(19) United States
(12) Patent Application Publication
(10) Pub. No.: US 2015/0262234 A1
(43) Pub. Date: Sep. 17, 2015

(54) NUTRITION ANALYSIS SYSTEM AND NUTRITION ANALYSIS PROGRAM

(71) Applicant: Seiko Epson Corporation, Tokyo (JP)

(72) Inventor: Yusuke SAKAGAMI, Shiojiri (JP)

(21) Appl. No.: 14/658,822

(22) Filed: Mar. 16, 2015

(30) Foreign Application Priority Data
Mar. 17, 2014 (JP) 2014-053139

(51) Int. Cl. G06Q 30/02

(52) U.S. Cl. CPC G06Q 30/0255; G06Q 30/0269

(57) ABSTRACT

A nutrition analysis system includes a customer information acquisition unit, a purchase history information acquisition unit, a nutrition analysis processing unit that calculates a required nutrient amount of a customer and performs nutrition analysis of the customer based on purchase history information of the customer and the required nutrition amount to generate nutrition analysis information of the customer, and a merchandise advertisement information supply unit that decides recommended merchandise for the customer based on the nutrition analysis information of the customer and supplies merchandise advertisement information including recommended merchandise notification information used to notify the customer of the recommended merchandise.

### BACKGROUND

1. Technical Field

The present invention relates to a nutrition analysis system and a nutrition analysis program.

2. Related Art

Systems performing dietary guidance effectively utilizing information regarding merchandise purchased by users have been proposed.

JP-A-2004-178476 discloses a merchandise information utilization system which inputs information regarding goods or services purchased by users and which supplies dietary guidance to users and supplies information regarding food or food ingredients being insufficient for users to stores.

However, in the merchandise information utilization system disclosed in JP-A-2004-178476, results of the dietary guidance was not able to be connected to increasing sales of stores since the supply of the dietary guidance to users and the supply of the information regarding the food or food ingredients insufficient for users to stores are merely performed separately.

Further, it is difficult for the users to be conscious of the contents of the dietary guidance and select merchandise since the contents of the dietary guidance and a merchandise purchase system are not linked.

### SUMMARY

An advantage of some aspects of the invention is to supply merchandise advertisement information displayed so that customers easily know recommended merchandise of each customer decided based on nutrition analysis information of each customer obtained by analyzing a purchase history of the customer. Another advantage of some aspects of the invention is to supply merchandise advertisement information in which a nutrition analysis simulation can be performed when a customer eats advertised food, using nutrition analysis information of each customer obtained by analyzing a purchase history of the customer.

### APPLICATION EXAMPLE 1

A nutrition analysis system according to this application example includes: a customer information acquisition unit that acquires customer information including attribute information of a customer; a purchase history information acquisition unit that acquires purchase history information of food of the customer; a nutrition analysis processing unit that calculates a required nutrient amount of the customer based on the attribute information of the customer and performs nutrition analysis of the customer based on the purchase history information and the required nutrient amount of the customer to generate nutrition analysis information of the customer; and a merchandise advertisement information supply unit that decides recommended merchandise for the customer based on the nutrition analysis information of the customer and supplies merchandise advertisement information including recommended merchandise notification information used to notify the customer of the recommended merchandise.

A management server according to this application example is a server that includes the units described above. A nutrition analysis program according to this application example is a program that causes a computer to function as the units described above. An information storage medium according to this application example is a computer-readable information storage medium that stores the program causing a computer to function as the units described above.

According to this application example, it is possible to supply the merchandise advertisement information displayed so that the customer easily knows the recommended merchandise of each customer decided based on the nutrition analysis information of each customer obtained by analyzing the purchase history of the customer. Accordingly, the customer can obtain the nutrition analysis information of the customer without troublesome report of the nutrition state of the customer and can be conscious of the nutrition state of the customer to select the merchandise. In a store, sales promotion can be achieved by performing merchandise advertisement using the nutrition analysis information of the customer.

### APPLICATION EXAMPLE 2

A nutrition analysis system according to this application example includes: a customer information acquisition unit that acquires customer information including attribute information of a customer; a purchase history information acquisition unit that acquires purchase history information of food of the customer; a nutrition analysis processing unit that calculates a required nutrient amount of the customer based on the attribute information of the customer and performs nutrition analysis of the customer based on the purchase history information and the required nutrient amount of the customer to generate nutrition analysis information of the customer; and a merchandise advertisement information supply unit that supplies merchandise advertisement information to the customer, acquires selection information which is information regarding merchandise selected from the merchandise advertisement information by the customer, performs nutrition analysis simulation when the customer eats the merchandise, based on the nutrition analysis information of the customer and merchandise specified by the selection information, and supplies nutrition analysis simulation information which is a result of the nutrition analysis simulation to the customer.

A management server according to this application example is a server that includes the units described above. A nutrition analysis program according to this application example is a program that causes a computer to function as the units described above. An information storage medium according to this application example is a computer-readable information storage medium that stores the program causing a computer to function as the units described above.

According to this application example, it is possible to supply the merchandise advertisement information so that the nutrition analysis simulation is performed when the customer eats the advertized food, using the nutrition analysis information of each customer obtained by analyzing the purchase history of the customer. Accordingly, the customer can obtain the nutrition analysis information of the customer without troublesome report of the nutrition state of the customer and can be conscious of the nutrition state of the customer to select the merchandise. In a store, sales promotion can be achieved by performing merchandise advertisement using the nutrition analysis information of the customer.

### APPLICATION EXAMPLE 3

In the nutrition analysis system according to the application example described above, the customer information acquisition unit may acquire health state information of the customer as the customer information. The nutrition analysis processing unit may perform the nutrition analysis of the customer using the health state information of the customer.

According to this application example, since the nutrition analysis information to which the health state information of the customer reported by the customer is reflected is generated and the merchandise advertisement information is supplied based on the nutrition analysis information, it is possible to supply the merchandise advertisement information to which a request from the customer is further reflected.

### APPLICATION EXAMPLE 4

In the nutrition analysis system according to the application example described above, the customer information acquisition unit may acquire, as the customer information, attribute information of a plurality of household members of the same household jointly consuming purchased food indicated by the purchase history information. The nutrition analysis processing unit may calculate a required nutrient amount of each member based on the attribute information of each of the household members forming the same household and use a value obtained by summing the required nutrient amounts of the plurality of household members forming the same household as the required nutrient amount of the customer.

According to this application example, the nutrition analysis to which information regarding the members of the household is reflected can also be performed on food displayed in units of households.

### APPLICATION EXAMPLE 5

In the nutrition analysis system according to the application example described above, the nutrition analysis processing unit may decide a cycle at which the nutrition analysis of the customer is performed based on a purchase frequency indicated by the purchase history information of the customer, calculate the required nutrient amount of the customer during a nutrition analysis period to correspond to the decided cycle, and perform the nutrition analysis of the customer based on the calculated required nutrient amount and the purchase history information of the customer during the nutrition analysis period.

According to this application example, since the cycle at which the nutrition analysis is performed according to a lifestyle (purchase frequency) of the customer is decided, it is possible to perform the nutrition analysis proper for the lifestyle of the customer.

### APPLICATION EXAMPLE 6

In the nutrition analysis system according to the application example described above, the purchase history information acquisition unit may acquire purchase history information of the customer at a plurality of stores. The nutrition analysis processing unit may perform the nutrition analysis of the customer using the purchase history information of the customer at the plurality of stores.

According to this application example, since the purchase history information of the customer at the plurality of stores can be managed in an integrated manner and the nutrition analysis is performed, it is possible to perform the more accurate nutrition analysis.

### BRIEF DESCRIPTION OF THE DRAWINGS

The invention will be described with reference to the accompanying drawings, wherein like numbers reference like elements.

FIG. 1 is a diagram illustrating a network configuration of a nutrition analysis system according to a first embodiment.

FIG. 2 is an exemplary functional block diagram of a management server.

FIG. 3 is a diagram for describing an overview of the nutrition analysis system according to the embodiment.

FIG. 4 is a diagram illustrating an example of merchandise advertisement information supplied in the system.

FIG. 5 is a diagram illustrating an example of merchandise advertisement information supplied in the system.

FIG. 6 is a diagram illustrating an example of merchandise advertisement information supplied in the system.

FIG. 7 is a diagram illustrating an example of merchandise advertisement information supplied in the system.

FIG. 8 is a diagram illustrating an example of merchandise advertisement information supplied in the system.

FIG. 9 is a diagram illustrating an example of statistical information.

FIGS. 10A and 10B are diagrams illustrating examples of statistical information.

FIGS. 11A and 11B are diagrams illustrating examples of customer information.

FIG. 12 is a diagram for describing a specific example of nutrition analysis according to the embodiment.

FIG. 13 is a diagram illustrating registered store information (which is an example of the customer information) .

FIG. 14 is a diagram illustrating an example of statistical information.

FIG. 15 is a diagram illustrating an example of statistical information.

FIG. 16 is a diagram illustrating an example of statistical information.

FIG. 17 is a diagram illustrating an example of statistical information.

FIG. 18 is a diagram illustrating an example of statistical information.

FIG. 19 is a diagram illustrating an example of nutrition analysis information.

FIG. 20 is a diagram for describing progress information regarding excess or deficiency of nutrients.

FIG. 21 is a flowchart illustrating the flow of a customer information registration process.

FIG. 22 is a flowchart illustrating the flow of a nutrition analysis process.

FIG. 23 is a flowchart illustrating the flow of a recommended merchandise information supply process.

FIG. 24 is a flowchart illustrating the flow of a nutrition analysis simulation process.

FIG. 25 is a diagram illustrating an example of merchandise advertisement information supplied in the system.

FIG. 26 is a diagram illustrating a network configuration of a nutrition analysis system according to a second embodiment.

FIG. 27 is a diagram illustrating an example of nutrition analysis information.

FIG. 28 is a diagram illustrating an example of purchase history information.

FIG. 29 is a diagram illustrating an example of recipe information.

### DESCRIPTION OF EXEMPLARY EMBODIMENTS

Hereinafter, embodiments will be described. The embodiments to be described do not inappropriately limit the contents of the invention described in the appended claims. All of the configurations described in the embodiments are not essential constituent requirements of the invention.

### 1. Configuration

### 1-1. Nutrition Analysis System According to First Embodiment

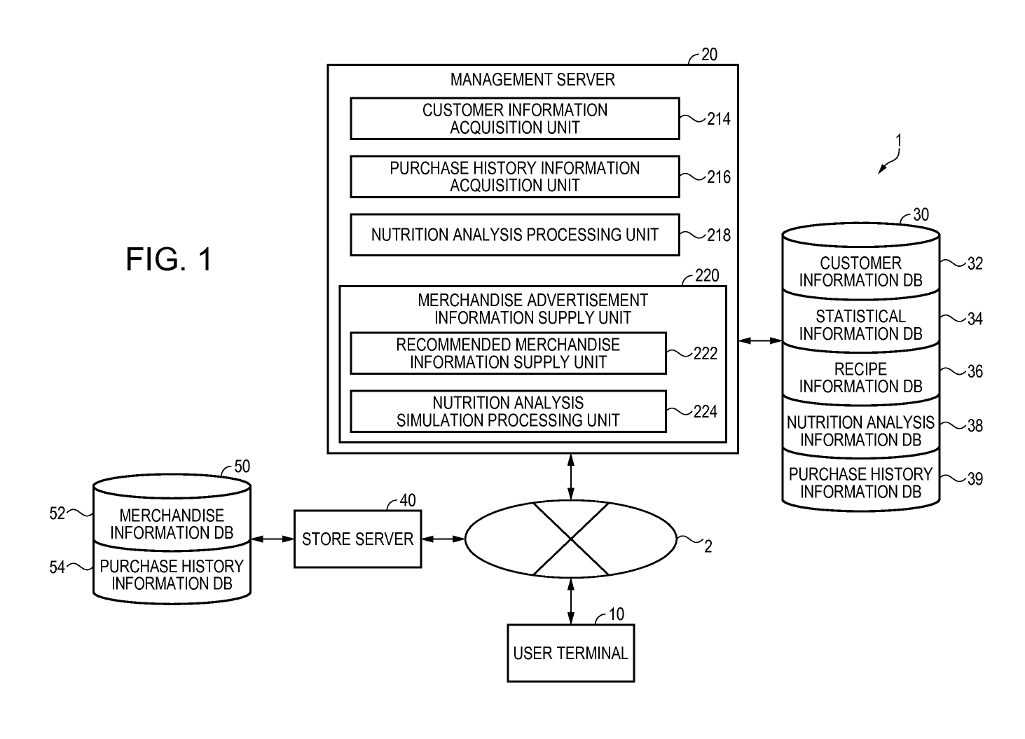

FIG. 1 is a diagram illustrating a network configuration of a nutrition analysis system 1 according to a first embodiment. The configuration of a management server 20 supplying merchandise advertisement information will be described according to the first embodiment.

The nutrition analysis system 1 according to the embodiment includes a management server 20 and a database 30 that is managed by the management server 20. The nutrition analysis system 1 may be configured to include a store server 40 for stores joining the nutrition analysis system and a database 50 that is managed by the store server. The number of stores joining the nutrition analysis system is not limited to one, but may be plural. The management server 20 is configured to be connected to the store server 40 via a communication network 2 such as the Internet, receives purchase history information of customers or merchandise information used for advertisement from the store server via the communication network 2, and transmits nutrition analysis information of customers of the stores to the store server 40.

The nutrition analysis system 1 may be configured to include a user terminal 10 (or may include a plurality of user terminals). The user terminal 10 is, for example, a smartphone, a mobile phone, a tablet terminal, a personal computer, a game terminal, and a network home appliance. The management server 20 is configured to be connected to the plurality of user terminals 10 via the communication network such as the Internet and supplies the merchandise advertisement information to the plurality of user terminals 10 via the communication network 2.

A user can use the user terminal 10 to access a site operated by the management server 20 or a site operated by the store server 40.

In the first embodiment, the management server 20 supplies the merchandise advertisement information. The user may access the store server 40 once to link from the store server 40 to the management server 20 so that the management server supplies the merchandise advertisement information (information regarding recommended food, a result of a nutrition analysis simulation process, and the like) to the user terminal 10.

The management server 20 functions as a customer information acquisition unit 214, a purchase history information acquisition unit 216, a nutrition analysis processing unit 218, a merchandise advertisement information supply unit 220, a recommended merchandise information supply unit 222, and a nutrition analysis simulation processing unit 224.

The management server 20 manages the database 30 such as a customer information database 32, a statistical information database 34, a recipe information database 36, a nutrition analysis information database 38, and a purchase history information database (management server side) 39.

The store server 40 manages the database 50 such as a merchandise information database 52 and a purchase history information database 54 (store server side). The purchase history information database 54 (store server side) accumulates a purchase history of a user in the store as purchase history information.

The management server 20 is supplied with the purchase history information of customers from the store server 40 and stores the purchase history information in the purchase history information database (management server side) 39. Since a plurality of stores join the nutrition analysis system 1, the management server 20 stores the purchase history information supplied from the plurality of store servers 40 in the purchase history information database (management server side) 39 in association with customer identification information. Accordingly, the purchase history information database (management server side) 39 stores the purchase history information in the plurality of stores of users.

### 1-2. Nutrition Analysis System According to Second Embodiment

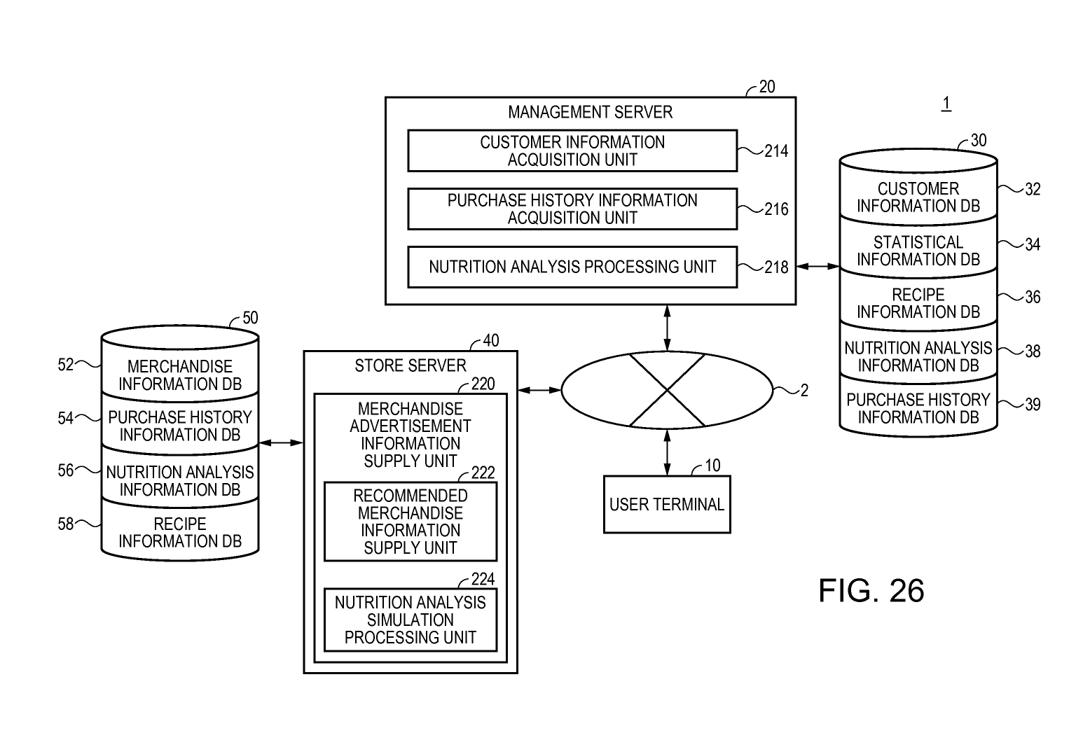

FIG. 26 is a diagram illustrating a network configuration of a nutrition analysis system 1 according to a second embodiment. The configuration of a store server 40 supplying merchandise advertisement information will be described according to the second embodiment.

The nutrition analysis system 1 according to the embodiment includes a management server 20, a database 30 that is managed by the management server 20, a store server 40 for stores joining in the nutrition analysis system, and a database 50 that is managed by the store server. The number of stores joining the nutrition analysis system is not limited to one, but may be plural. The management server 20 is configured to be connected to the store server 40 via a communication network 2 such as the Internet, receives purchase history information of customers or merchandise information used for advertisement from the store server, and transmits nutrition analysis information of customers of the store to the store server 40 via the communication network 2.

The nutrition analysis system 1 may be configured to include a user terminal 10 (or may include a plurality of user terminals). The user terminal 10 is, for example, a smartphone, a mobile phone, a tablet terminal, a personal computer, a game terminal, and a network home appliance. The store server 40 is configured to be connected to the plurality of user terminals 10 via the communication network 2 such as the Internet and supplies the merchandise advertisement information to the plurality of user terminals 10 via the communication network 2.

A user can use the user terminal 10 to access a site operated by the management server 20 or a site operated by the store server 40.

In the second embodiment, the store server 40 supplies the merchandise advertisement information. The management server 20 performs a process of supplying the user terminal 10 with a customer information registration screen (customer information registration image) on which a customer registers customer information. In the second embodiment, the store server 40 receives the nutrition analysis information of the customer supplied by the management server 20 and retains the nutrition analysis information in a nutrition analysis information database (store server side) 56 managed by the store server.

The store server 40 functions as a merchandise advertisement information supply unit 220, a recommended merchandise information supply unit 222, and a nutrition analysis simulation processing unit 224. The management server 20 functions as a customer information acquisition unit 214, a purchase history information acquisition unit 216, and a nutrition analysis processing unit 218.

The store server 40 supplies the merchandise advertisement information (information regarding recommended food, a result of a nutrition analysis simulation process, and the like) based on the nutrition analysis information retained in the nutrition analysis information database (store server side) 56.

The management server 20 is supplied with the purchase history information of the customer from the store server 40 and stores the purchase history information in the purchase history information database (management server side) 39. Since a plurality of stores join the nutrition analysis system 1, the management server 20 stores the purchase history information supplied from the plurality of store servers 40 in the purchase history information database (management server side) 39 in association with customer identification information. Accordingly, the purchase history information database (management server side) 39 stores the purchase history information in the plurality of stores of users.

### 1-3. Configuration of Management Server

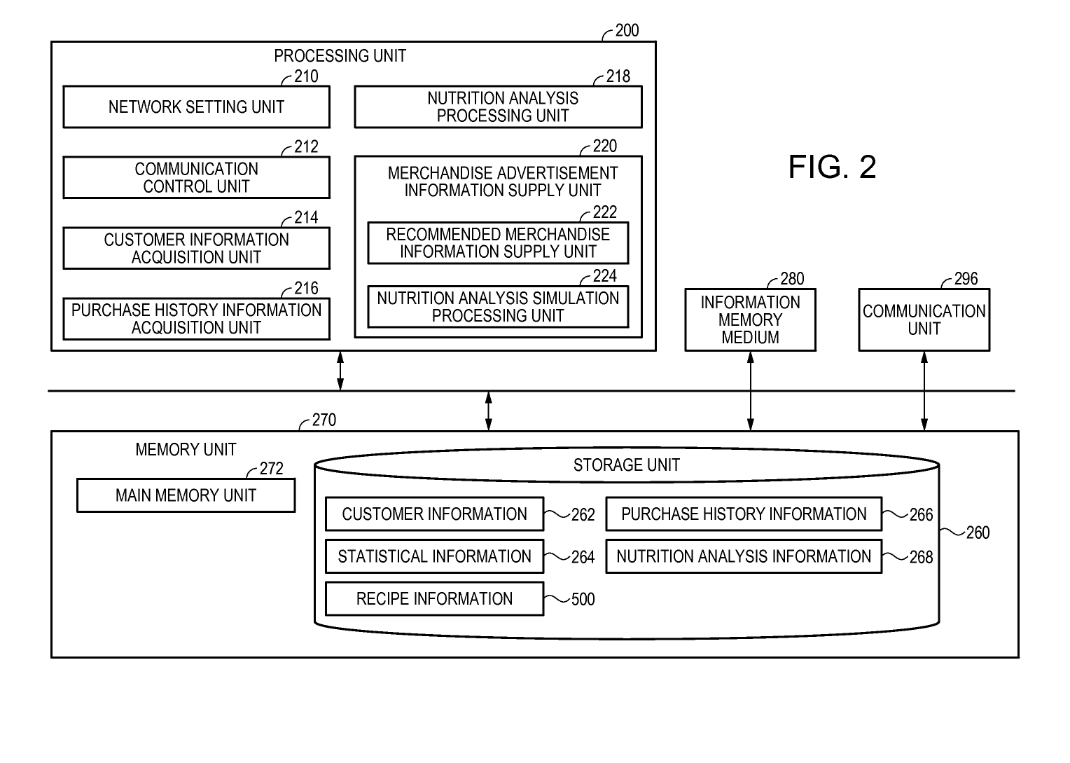

FIG. 2 is an exemplary functional block diagram of the management server 20 according to the embodiment. The management server 20 may have a configuration in which some of the constituent elements (respective units) in FIG. 2 may be omitted.

The management server 20 includes a memory unit 270, a processing unit 200, a communication unit 296, and an information memory medium 280.

The memory unit 270 includes a storage unit 260 (for example, a database). The storage unit 260 stores customer information 262 and functions as a customer information database (32 in FIG. 1). The storage unit 260 stores statistical information 264 and functions as a statistical information database (34 in FIG. 1). The storage unit 260 stores purchase history information 266 and functions as a purchase history information database (39 in FIG. 1). The storage unit 260 stores nutrition analysis information 268 and functions as a nutrition analysis information database (38 in FIG. 1). The storage unit 260 stores recipe information 500 and functions as a recipe information database (36 in FIG. 1).

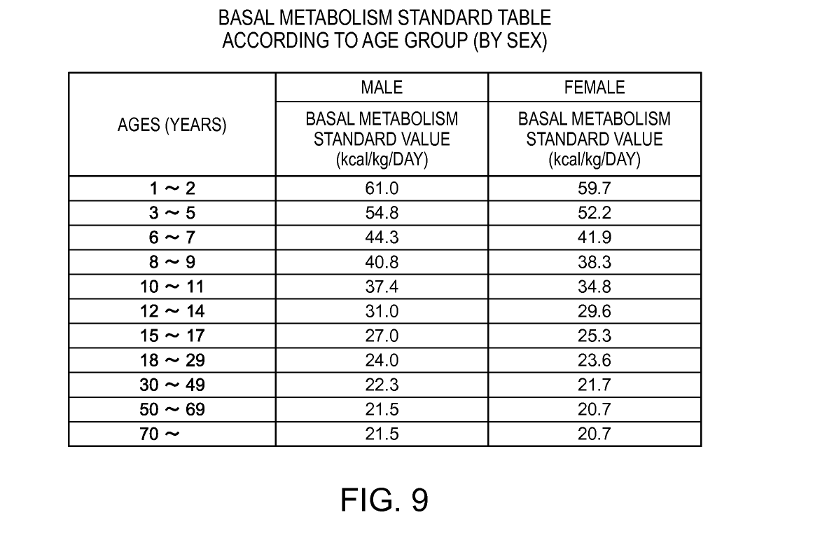

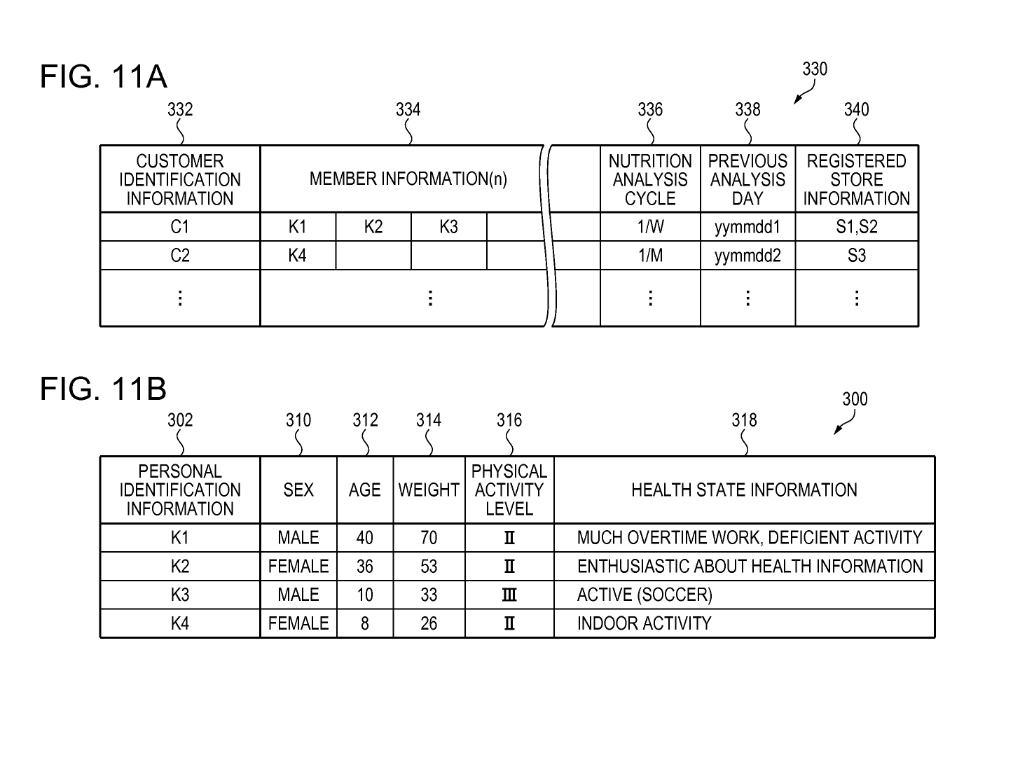

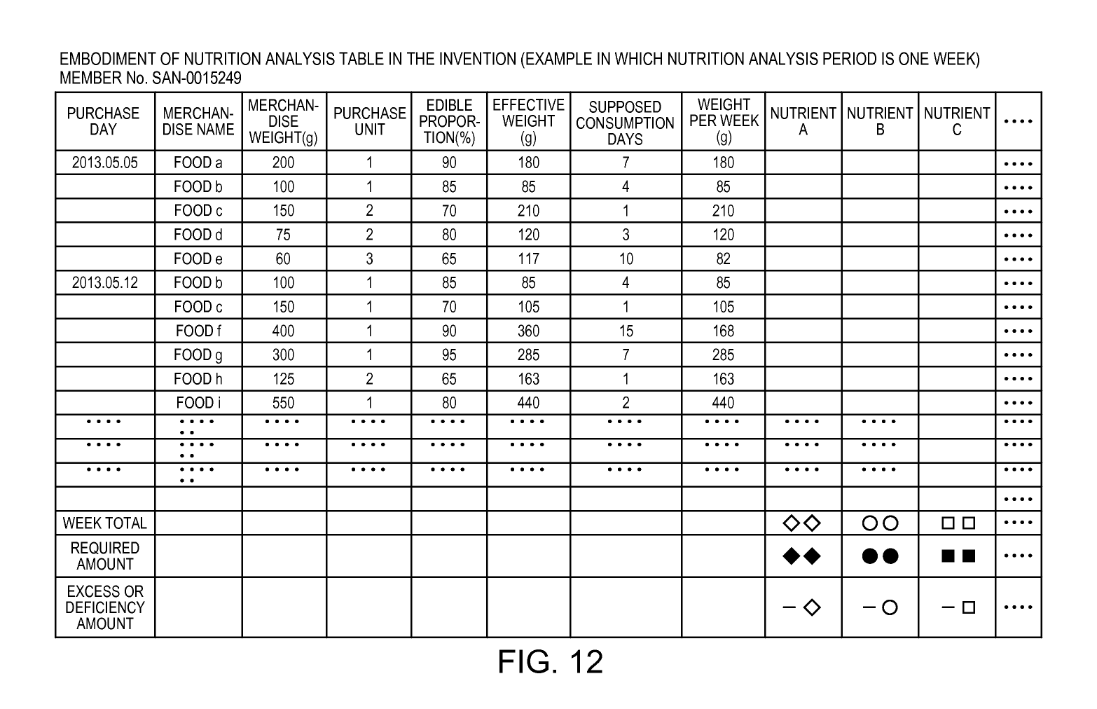

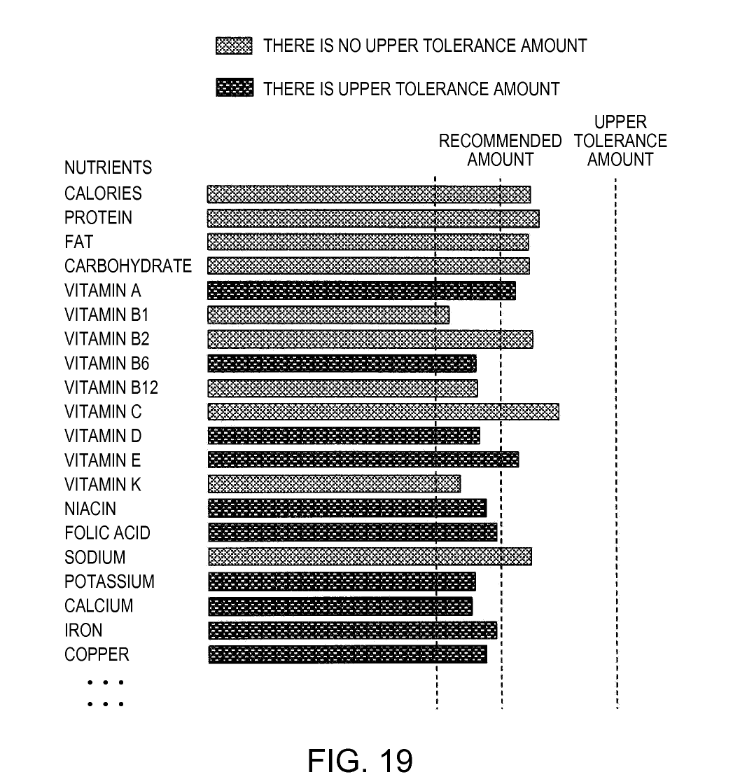

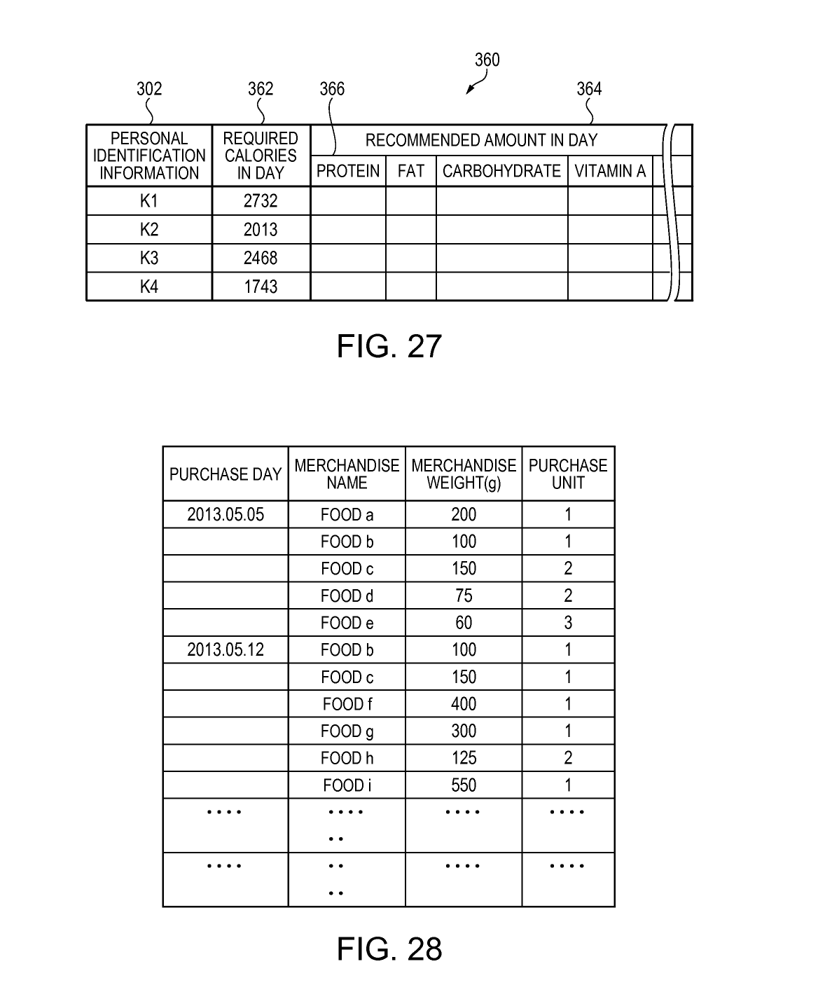

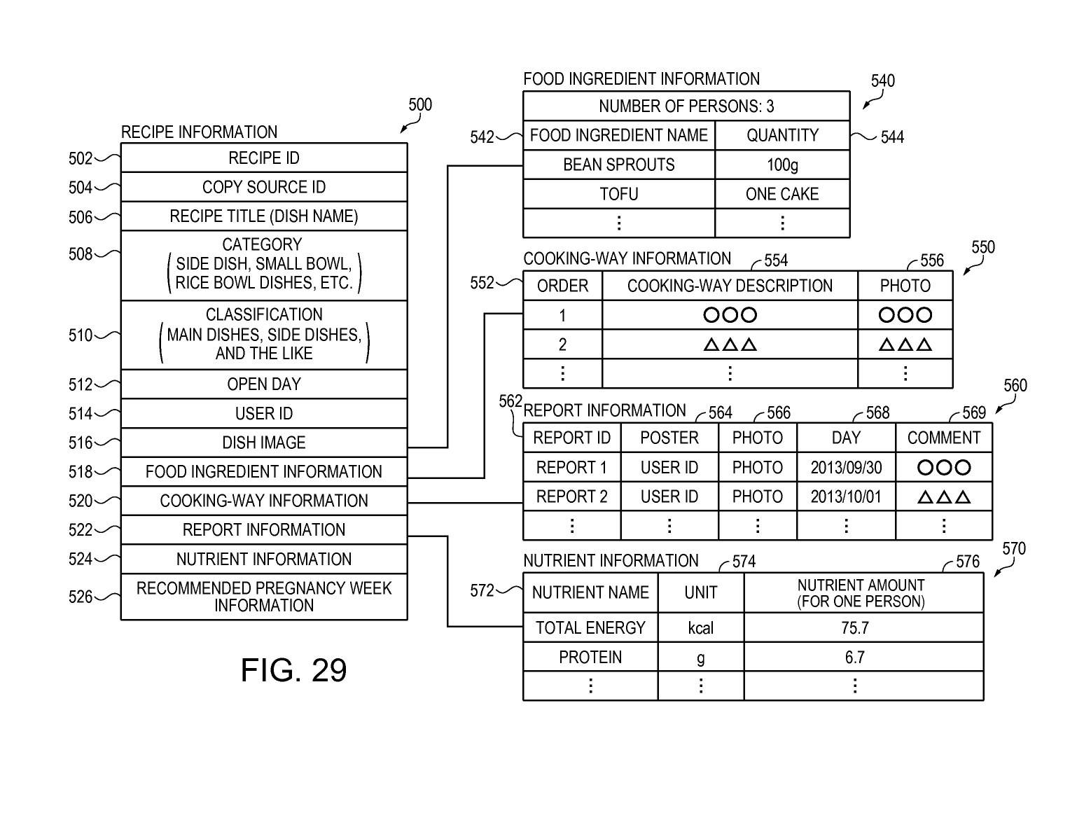

The customer information 262 includes information illustrated in FIGS. 11A and 11B. The statistical information 264 includes information illustrated in FIGS. 9, 10A, 10B, and 14 to 19. The recipe information 500 includes information illustrated in FIG. 29. The nutrition analysis information 268 includes information illustrated in FIG. 27 or 19. The purchase history information 266 includes information illustrated in FIG. 28.

The information memory medium 280 (a computer-readable medium) stores a program, data, and the like.

The processing unit 200 performs various processes according to the embodiment based on the program (data) stored in the information memory medium 280. That is, the information memory medium 280 stores a nutrition analysis program (a program causing a computer to perform a process of each unit) causing a computer to function as each unit according to the embodiment.

The communication unit 296 performs various kinds of control to communicate with the outside (for example, a terminal or another server). The function can be realized by hardware such as various processors or a communication ASIC, a program, or the like.

The processing unit 200 (processor) performs a process based on the program or the like stored in the information memory medium 280. Specifically, a service is supplied in response to a request from a terminal. The function of the processing unit 200 is realized by hardware such as various processors (a CPU, a DSP, and the like), an ASIC (a gate array or the like) or a program.

The processing unit 200 includes a network setting unit 210, a communication control unit 212, a customer information acquisition unit 214, a purchase history information acquisition unit 216, a nutrition analysis processing unit 218, and a merchandise advertisement information supply unit 220. Some of these units may be configured to be omitted.

The network setting unit 210 receives identification information of the user terminal 10 and stores network information of the user in the storage unit 260 in association with the received terminal identification information.

The communication control unit 212 performs a process of transmitting or receiving data to or from the store server 40 or another computer such as the user terminal 10 via the network.

A process of the merchandise advertisement information supply unit 220 may be performed by the management server 20, or all or some of the processes may be performed by the user terminal 10 or the store server 40.

The customer information acquisition unit 214 acquires customer information including attribute information of a customer. The acquired customer information may be stored as the customer information 262 in the storage unit 260 in association with the customer identification information. The purchase history information acquisition unit 216 acquires the purchase history information of food of a customer. The acquired purchase history information may be stored as the purchase history information 266 in the storage unit 260 in association with the customer identification information. The nutrition analysis processing unit 218 calculates a required nutrient amount of the customer based on the attribute information of the customer and performs nutrition analysis for the customer to generate nutrition analysis information of the customer based on the purchase history information 266 and the required nutrient amount of the customer.

The merchandise advertisement information supply unit 220 includes a recommended merchandise information supply unit 222 to supply merchandise advertisement information to a customer. The recommended merchandise information supply unit 222 decides recommended merchandise for the customer based on the nutrition analysis information of the customer and supplies merchandise advertisement information including recommended merchandise notification information to notify the customer of the recommended merchandise included in the merchandise advertisement information.

The merchandise advertisement information supply unit 220 includes a nutrition analysis simulation processing unit 224 that acquires the customer identification information of the customer and selection information of merchandise posted in the merchandise advertisement information and supplies merchandise advertisement information including nutrition analysis simulation information for notifying of a result of nutrition analysis simulation obtained by performing the nutrition analysis simulation when the customer eats the merchandise based on the merchandise specified by the nutrition analysis information of the customer specified by the acquired customer identification information and the selection information.

The customer information acquisition unit 214 acquires health state information of the customer as customer information and the nutrition analysis processing unit 218 performs the nutrition analysis of the customer using the health state information of the customer.

The customer information acquisition unit 214 acquires, as customer information, attribute information of a plurality of household members of the same household in which purchased food indicated by the purchase history information 266 is consumed jointly. The nutrition analysis processing unit 218 may calculate a required nutrient amount of each member based on the attribute information of each of the household members of the same household and use a value obtained by adding the required nutrient amounts of the plurality of household members of the same household as the required nutrient amount of the customer.

The nutrition analysis processing unit 218 may decide a cycle at which the nutrition analysis of the customer is performed based on a purchase frequency indicated by the purchase history information 266 of the customer, calculate a required nutrient amount of the customer during a nutrition analysis period in correspondence to the decided cycle, and perform the nutrition analysis of the customer based on the calculated required nutrient amount and the purchase history information 266 of the customer during the nutrition analysis period.

The purchase history information acquisition unit 216 may acquire the purchase history information 266 of a customer in regard to the plurality of stores and the nutrition analysis processing unit 218 may perform the nutrition analysis of the customer using the purchase history information 266 of the customer in regard to the plurality of stores.

### 2. Process According to Embodiment

### 2-1. Overview of System

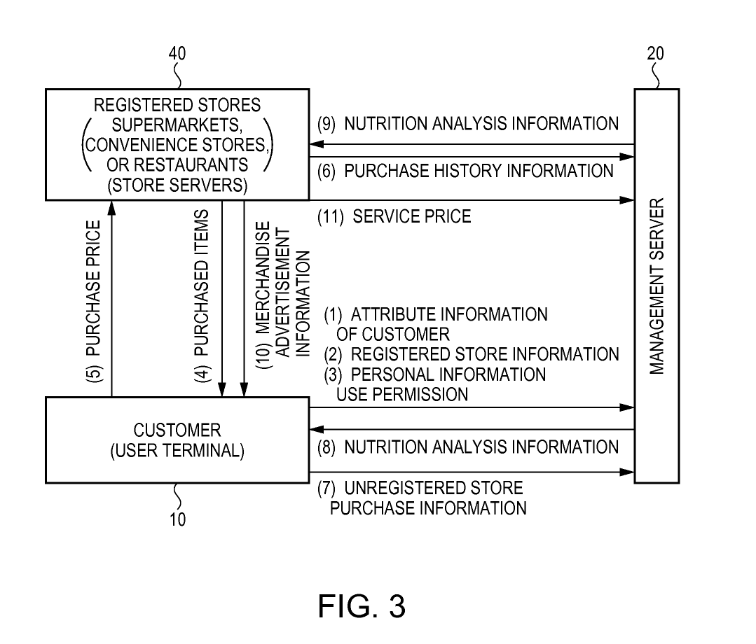

FIG. 3 is a diagram for describing an overview of the nutrition analysis system according to the embodiment. Registered stores refer to stores used by customers and stores supplying food to the customers, such as supermarkets, restaurants, or convenience stores.

A customer uses the user terminal 10 to perform, for example, registration of customer information (1), registration of a store to be used (2), and registration of personal information use permission (3) to the management server 20. When the customer performs purchase of merchandise (food) from the registered store (4) and payment of purchase prices to the registered store (5), the purchase history information of the customer is accumulated in the registered store. For example, POS information of a POS system aggregating sales results of merchandise sales in units of single items can be used as the purchase history information. The store server 40 of the registered store supplies the purchase history information of the customer to the management server 20 (6), and the management server 20 manages the purchase history information of the customer supplied by the plurality of registered stores in units of customers and generates nutrition analysis information by performing a nutrition analysis process for the customer based on the purchase history information of the customer. The customer can transmit purchase information of food in an unregistered store to the management server 20 and register the purchase information as purchase history information (7). The management server 20 performs a process of supplying the nutrition analysis information to the customer (8) or a process of supplying the nutrition analysis information to the registered store (9). The registered store supplies the customer with the merchandise advertisement information (10) (including electronic advertisement or a purchase screen to be described below).

When the system is configured as in the first embodiment (FIG. 1), the management server 20 may supply (10) the merchandise advertisement information (including electronic advertisement or a purchase screen to be described below).

The management server 20 can perform proper nutrition guidance based on the purchase history for the user by supplying the nutrition analysis information to the customer. The management server 20 supplies the nutrition analysis information to the registered store, and thus the registered store can perform sales promotion for the registered store by supplying the customer with foods (including menu information using the foods) containing many nutrients deficient in the customer as information regarding recommended food using the nutrition analysis information of the customer.

In the embodiment, when the merchandise advertisement information is supplied, recommended food information is supplied or the nutrition analysis simulation is performed. Thus, the customer can be conscious of nutrition management more easily and select the merchandise, and thus the store can perform advertisement with higher sales promotion effects.

### 2-2. Customer Information

FIGS. 11A and 11B are diagrams for describing customer information.

The customer information (262 in FIG. 2) according to the embodiment includes household information 330 (FIG. 11A) managed in units of households and personal information 300 (FIG. 11B) managed in units of persons. As the household information 330, for example, member information 334, a nutrition analysis cycle 336, a previous analysis day 338, and registered store information 340 are stored in association with customer identification information 332.

As the personal information 300, attribute information such as sex 310, age 312, weight 314, physical activity level 316, and health information 318 are stored in association with personal identification information 302. The health information 318 is an example of the health state information and includes information regarding a customer health state registered by the customer.

Thus, an intake nutrition amount of the customer as a household can be comprehended from the purchase history (purchase history information) of the foods in the store registered by the customer. Since the attribute information of a person in the household of the customer can be acquired from the customer information registered by the customer, a required nutrition amount (recommended nutrition amount) of the person as the member can be obtained and a required nutrient amount of the household can be obtained from the required nutrition amount of the person. Further, for example, information regarding an excessive or deficient amount of each nutrient can be obtained in units of households from the intake nutrient amount of the household and the required nutrient amount of the household and the nutrition analysis information can be generated in units of customers.

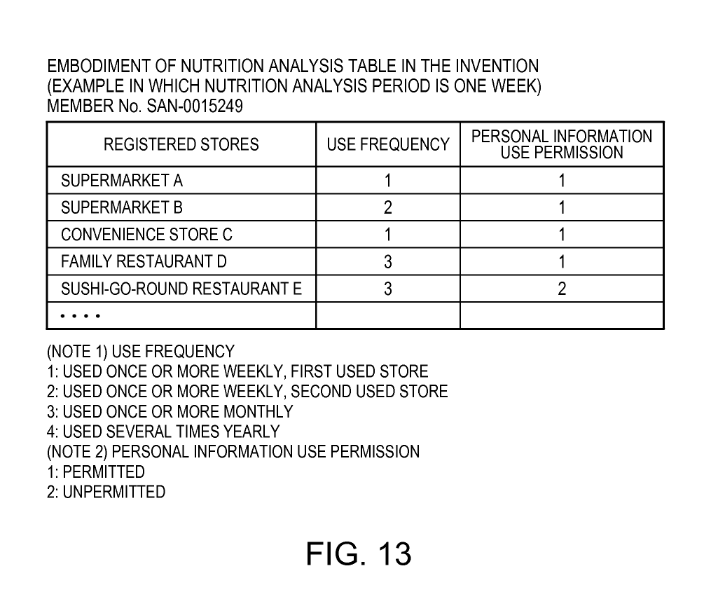

FIG. 13 is a diagram illustrating registered store information (an example of the customer information) according to the embodiment.

As the registered store information, the registered stores among the relatively used stores and whether to permit use of the personal information in the stores are stored for each customer (member). Information regarding a use frequency of the registered store can be obtained based on food purchase history information acquired from each store. The personal information use permission is set with a value registered from the user for each store at the time of registration of customer information.

### 2-3. Customer-Classified Recommended Nutrient Amount

FIG. 27 is a diagram illustrating a customer-classified recommended nutrient amount.

In customer-classified recommended nutrition amount 360, personal required calories 362 in a day, a recommended amount 364 of each nutrient (protein 366, etc.) in a day, and the like are stored in association with the personal identification information 302. These amounts are values calculated based on the attribute information (FIG. 11B) of the person and the statistical information. A calculation method will be described in “2-5 Process of Calculating Required Calories During Nutrient Analysis Period” and “2-6. Process of Calculating Required Amount of Each Nutrient During Nutrition Analysis Period.”

### 2-4. Setting of Nutrient Analysis Period

The nutrition analysis cycle (336 in FIGS. 11A and 11B) is a cycle at which the nutrition analysis is performed. For example, when the nutrition analysis is performed once per week (“1/W”), the nutrition analysis period is one week. The nutrition analysis period such as one month, three months, six months, or one year can be appropriately set.

In the embodiment, required amounts of nutrients (required nutrient amount) of the customer are calculated in units of the nutrition analysis periods. That is, when the nutrition analysis period is one week, the required nutrient amount of the customer per week is calculated. In the embodiment, the amounts of nutrients which the customer can acquire from food purchased by the customer during the nutrition analysis period are calculated by the purchase history information of the food of the customer. That is, when the nutrition analysis period is one week from d day m month, the amounts of nutrients which the customer acquires are calculated from the food purchase history during one week from d day m month.

The nutrition analysis cycle or the nutrition analysis period can be appropriately set in the system. In the system, the nutrition analysis cycle or the nutrition analysis period may be set based on a purchase frequency of food indicated by the purchase history information of the food. As the use frequency of the store is higher, the nutrition analysis cycle is preferably set to be shorter. By doing so, it is possible to perform the nutrition analysis of the customer so that latest information is normally reflected. For example, the nutrition analysis cycle may be set according to an average of the use frequency of the store. That is, when the average of the use frequency of the store is one per week, the cycle at which the nutrition analysis is performed may be set to one per week.

### 2-5. Process of Calculating Required Calories During Nutrient Analysis Period

FIG. 9 illustrates a basal metabolism standard table (which is an example of the statistical information) according to age groups used in the embodiment. As illustrated in the drawing, basal metabolism standard values by sex are defined according to each age group. Basal metabolism of the customer is obtained using this table and the attribute information (age, weight, and the like) of the customer. For example, when the age and weight of a male are 40 years and 70 kg, basal metabolism of the male can be obtained as follows.

22.3 (kcal/kg/day)×70 (kg)=1,561 (kcal/day) (Expression 1)

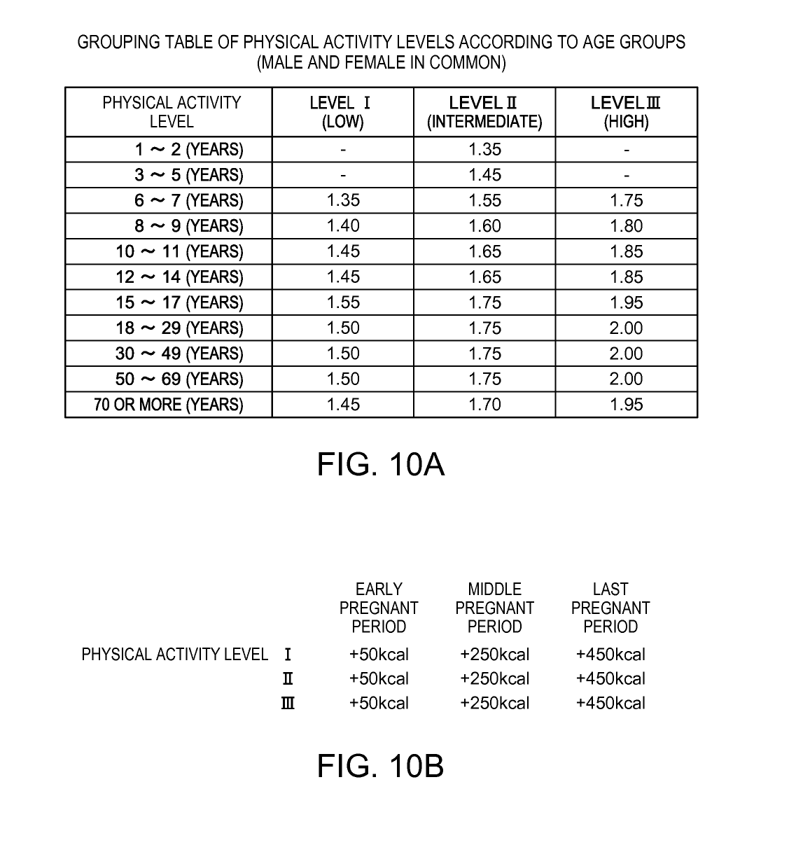

FIG. 10A illustrates a grouping table (which is an example of the statistical information) of the physical activity level according to the age groups.

The physical activity level (PAL) mainly refers to an index of physical activities. The physical activity level is defined as an index obtained by dividing a total energy consumption amount measured according to a doubly labeled water method by a basal metabolism amount and can be obtained by the following expression.

Physical activity level=total energy consumption amount per day÷basal metabolism amount per day

For example, when the physical activity level of the male of which the age is 40 years and the weight is 70 kg is level 2, the basal metabolism is 1,561 (kcal/day) by (Expression 1). Therefore, required calories in a day are as follows.

1,561 (kcal)×1.75=2,732 (kcal/day) (Expression 2)

When a female is pregnant, information such as pregnancy periods (an early period, a middle period, and a last period) or a lactation period is added. In the case of a pregnant woman, additional amounts (kcal/day) in FIG. 10B are added.

The required calories or required amounts of nutrients during the nutrition analysis period are calculated based on the personal information of the customer illustrated in FIG. 11B.

The required calories in a day are expressed in (Expression 1) or (Expression 2) and can be calculated according to the following expression.

Basal metabolism (kcal/day)=basal metabolism standard value (kcal/kg/day)×weight (kg) (Expression 3)

Required calories in a day (kcal/day)=basal metabolism (kcal/day)×index of physical activity level (Expression 4)

### 2-6. Process of Calculating Required Amount of Each Nutrient During Nutrition Analysis Period

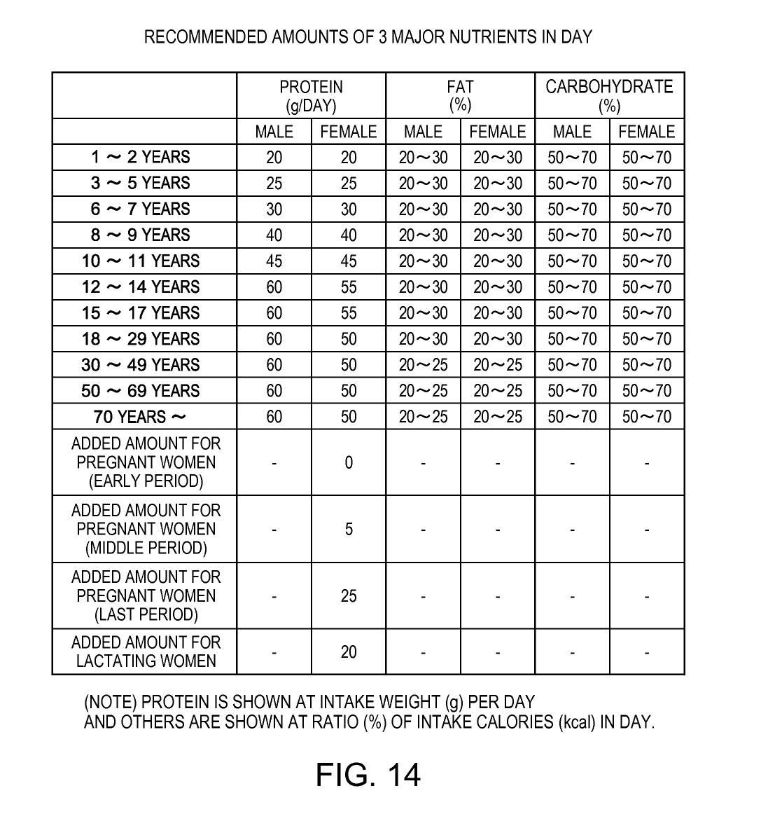

FIG. 14 illustrates statistical information indicating recommended amounts of three major nutrients (protein, fat, and carbohydrate) in a day. Protein is shown at an intake weight (g) per day and fat and carbohydrate are shown at a ratio (%) of an intake calorie (kcal) in a day. Since the required calories of each customer in a day can be known according to (Expression 3), (Expression 4), or the like, a total of the household can be calculated. For protein, fat, and carbohydrate in the required calories, a total sum of the members of the household can also be calculated. By changing these values into values during the nutrition analysis period (for example, one week or one month), a recommended amount of each nutrient during the nutrition analysis period is calculated.

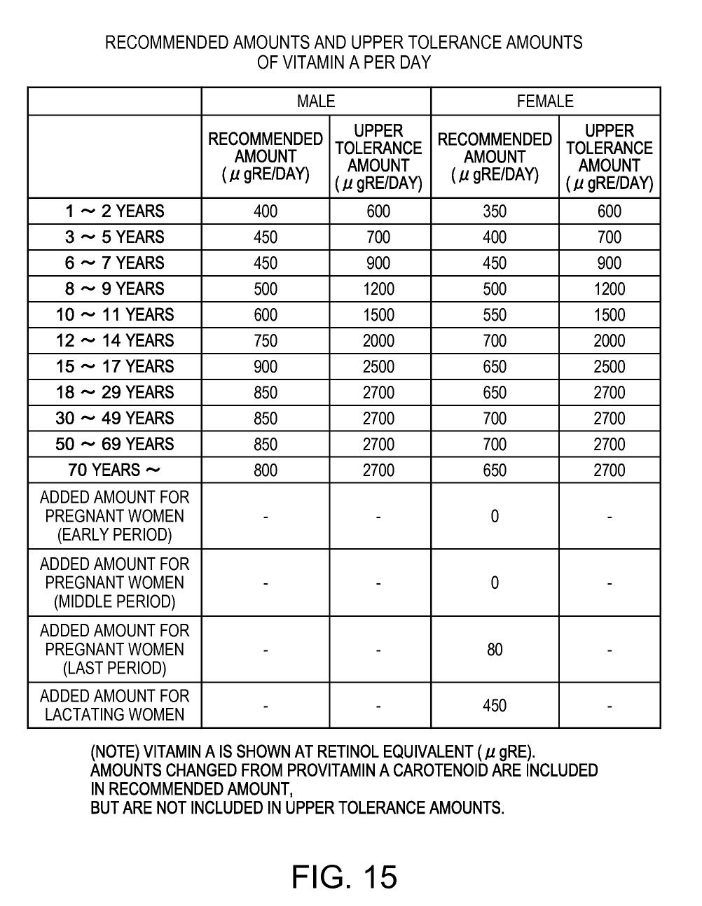

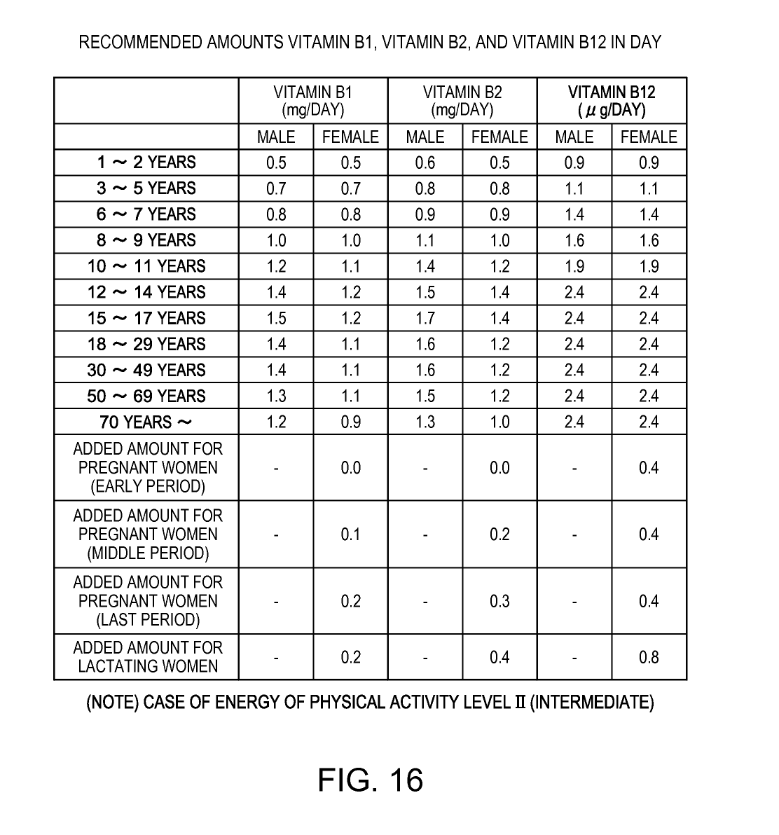

FIG. 15 illustrates statistical information indicating recommended amounts and upper tolerance doses of vitamin A. FIG. 16 illustrates statistical information indicating recommended amounts of vitamin B1, vitamin B2, and vitamin B12. Vitamins are classified into a first group in which recommended amounts and upper tolerance amounts in a day are regulated and a second group in which only recommended amounts in a day are regulated. The first group includes vitamin A, vitamin D, vitamin E, niacin, vitamin B6, and folic acid. The second group includes vitamin B1, vitamin B2, vitamin B12, vitamin C, vitamin K, and pantothenic acid.

Recommended amounts of such vitamins for the household can be calculated from the recommended amounts of personal members of the household of the customer. By changing these values into values during the nutrition analysis period (for example, one week or one month), recommended amounts of vitamins during the nutrition analysis period are calculated.

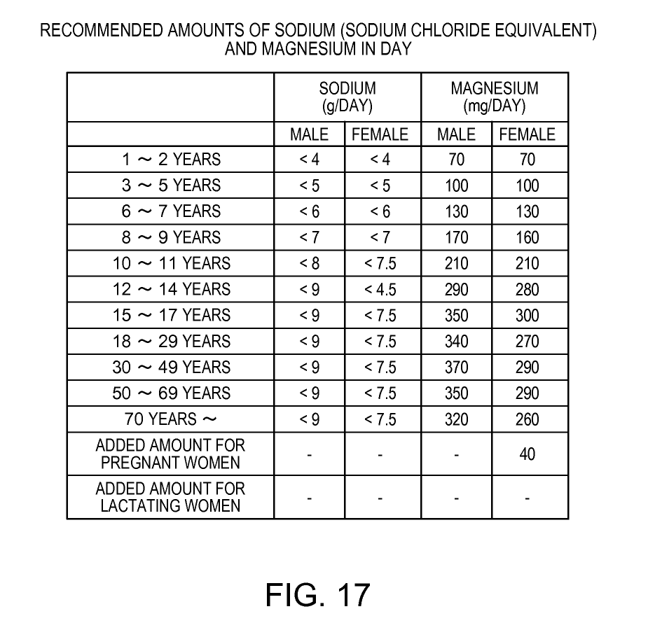

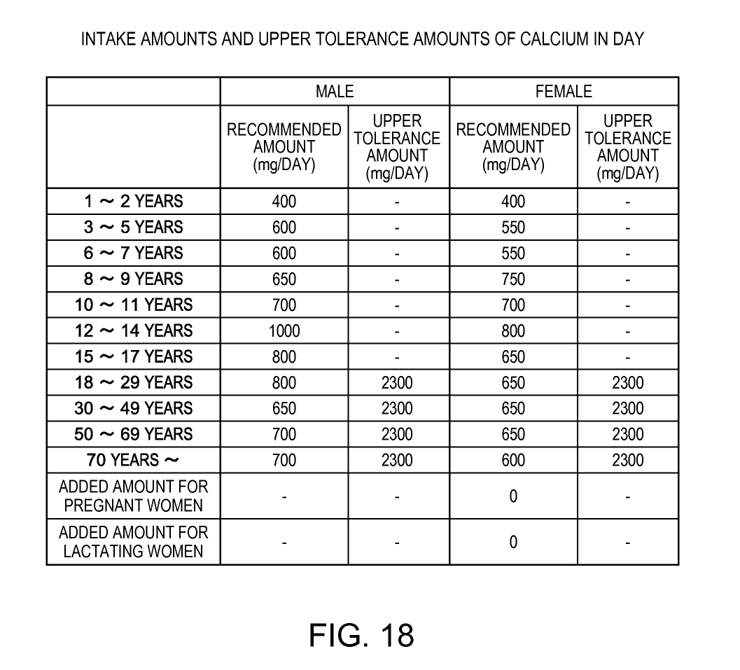

FIG. 17 illustrates recommended amounts of sodium and magnesium in a day. FIG. 18 illustrates statistical information indicating recommended amounts and upper tolerance amounts of calcium in a day.

Minerals are classified into a first group in which recommended amounts and upper tolerance amounts in a day are regulated, a second group in which only recommended amounts in a day are regulated, and a third group in which adequate intakes and target amounts in a day are regulated. The first group includes calcium, phosphorus, iron, zinc, and copper, the second group includes sodium and magnesium, and the third group includes potassium.

Recommended amounts of such minerals for the household can be calculated from the recommended amounts of personal members of the household of the customer. By changing these values into values during the nutrition analysis period (for example, one week or one month), recommended amounts of minerals during the nutrition analysis period are calculated.

### 2-7. Process of Calculating Nutrients Acquired During Nutrient Analysis Period

FIG. 12 is a diagram for describing a specific example of the nutrition analysis according to the embodiment.

In the embodiment, the amounts of nutrients acquired by the customer from purchased food during a given period (a nutrition analysis period determined by the nutrition analysis cycle) are calculated based on the food purchase history information of the customer.

When the nutrients (nutrient A, nutrient B, and nutrient C) contained in each food are calculated, “Standard tables of food composition in Japan 2010” (food listing number: 1,878) of Ministry of Education, Culture, Sports, Science and Technology may be memorized as the statistical information and the nutrients may be calculated using the Standard tables of food composition in Japan 2010. The nutrients to be calculated are, for example, energy, moisture, protein, fat, carbohydrate, sodium, potassium, magnesium, phosphorus, iron, zinc, copper, manganese, iodine, selenium, chromium, molybdenum, vitamin A (retinol, α-carotene, β-carotene, β-cryptoxanthin, β-carotene equivalent, and retinol equivalent), vitamin D, vitamin E (α-tocopherol, β-tocopherol, γ-tocopherol, and δ-tocopherol), vitamin K, vitamin B1, vitamin B2, niacin, vitamin B6, vitamin B12, folic acid, pantothenic acid, biotin, and vitamin C.

First, an effective weight (g) of purchased food is calculated from a merchandise weight (g) of the purchased food in units of purchase and an edible proportion (%) of the purchased food.

Merchandise weight (g)×purchase number×edible proportion (%)=effective weight (g) (Expression 5)

When the nutrition analysis period is one week, an intake weight (g) per week is calculated as follows.

intake weight (g) per week=effective weight (g)×(consumption coefficient)

(in the expression, a consumption coefficient P (1 W) is set to P (1 W)=1 in the case of supposed consumed days D≦7, and set to P (1 W)=7/D in the case of supposed consumed days D>7)

### 2-8. Process of Calculating Nutrient Excess or Deficiency Information

FIG. 19 is a diagram for describing excess or deficiency information of the nutrients during the nutrition analysis period.

When the nutrition analysis period is set to one week, the recommended amounts and the upper tolerance amounts of intake amounts of the customer in units of households are indicated by bar graphs according to the nutrients of the foods eaten during the nutrition analysis period.

The recommended amounts and the upper tolerance amounts of the intake amounts of the customers in units of households during the nutrition analysis period are obtained according to the method described in “2-6. Process of Calculating Required Amount of Each Nutrient During Nutrition Analysis Period.”

### 2-9. Process of Supplying Nutrition Analysis Information

In the embodiment, nutrient excess or deficiency information illustrated in FIG. 19 is retained as nutrition analysis information of the customer during a predetermined period. A process of supplying the nutrition analysis information to a customer or a store may be performed. A process of supplying the recommended food information to which the nutrition analysis result of the customer is reflected when the merchandise advertisement information is supplied using the nutrition analysis information may be performed. A nutrition analysis simulation process to which the nutrition analysis result of the customer is reflected when the merchandise advertisement information is supplied using the nutrition analysis information may be performed.

A process of generating nutrition advice information based on the nutrition analysis information and supplying the nutrition advice information to a customer may be performed. For example, nutrition advice information giving an instruction to increase or decrease eaten food so that the amounts of nutrients become the recommended amounts of the nutrients may be generated. When the nutrients have the upper tolerance amounts, nutrition advice information giving an instruction not to exceed the upper amounts may be generated.

Based on the nutrient excess or deficiency information during one week which is the nutrition analysis period, intake of meals during one week is contrived in consideration of a meal menu in which food containing relatively many deficient nutrients is used. For example, when folic acid is insufficient, nutrition advice information giving an instruction to eat many dark green vegetables such as spinach may be generated. In contrast, when the customer eats many vegetables and the amount of vegetables approaches the upper tolerance amount, nutrition advice information giving an instruction to restrict intake of the food containing the relatively many nutrients may be generated. For example, when the customer excessively eats calcium with a nutritional supplement and an intake amount of the nutritional supplement can be understood to adjust the intake amount of the nutritional supplement or provide calcium with a normal meal, nutrition advice information giving an instruction to cancel the intake of the nutritional supplement may be generated.

The system may periodically perform, for example, a process of supplying the nutrition advice information to the customer at a timing interlocked with the nutrition analysis period. As will be described below, a process of supplying the customer with nutrition advice information corresponding to the food selected by the customer at a timing at which the nutrition analysis process is performed based on an instruction from the customer may be performed.

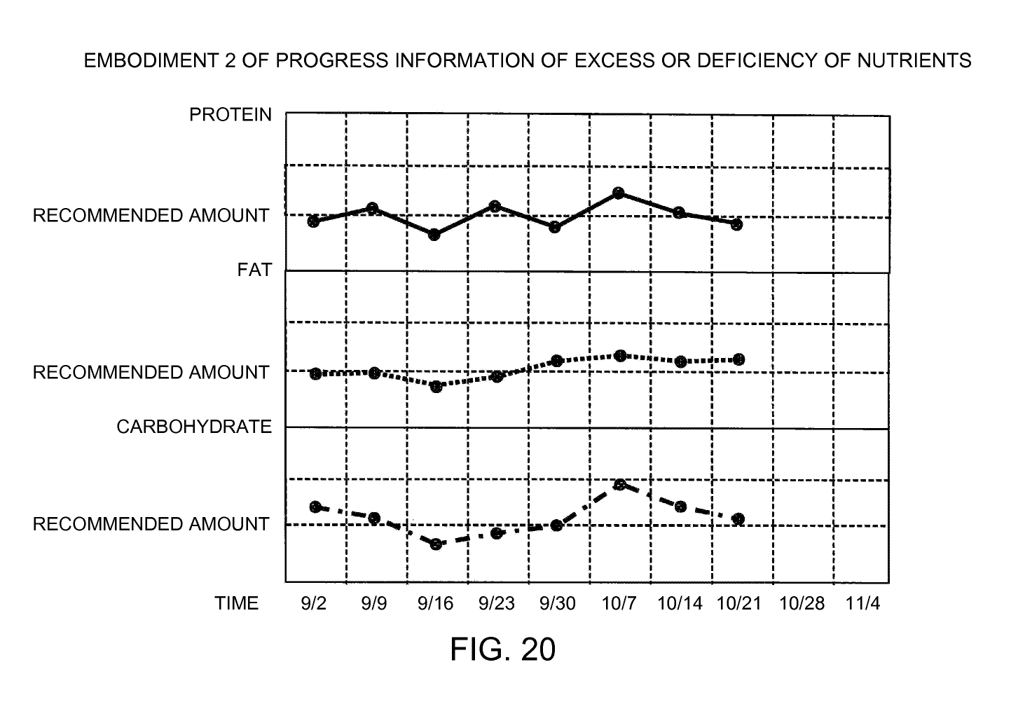

FIG. 20 is a diagram for describing progress information of excess or deficiency of the nutrients (protein, fat, and carbohydrate). When the nutrition analysis period is set to one week, a progress of the intake amount is displayed according to each nutrient of foods eaten during one week, and thus, for example, the meal menu can be understood to be adequate. In particular, for example, when social dining-out continues or the customer takes a trip, it is difficult to manage meals, and thus nutrition balance is collapsed. In this case, it is necessary to contrive a meal menu so that excess or deficiency of nutrition becomes normal during the following one week. A process of generating progress information of the excess or deficiency of the nutrients and supplying the progress information to the customer may be performed.

### 2-10. Customer Information Registration Process

The management server 20 can access a recipe nutrition analysis service supply site and perform registration of the customer information via the user terminal of the user, since the site is opened on a web, to be supplied with a nutrition analysis service. For example, the nutrition analysis advice information described in “2-9. Process of Supplying Nutrition Analysis Information” can be supplied.

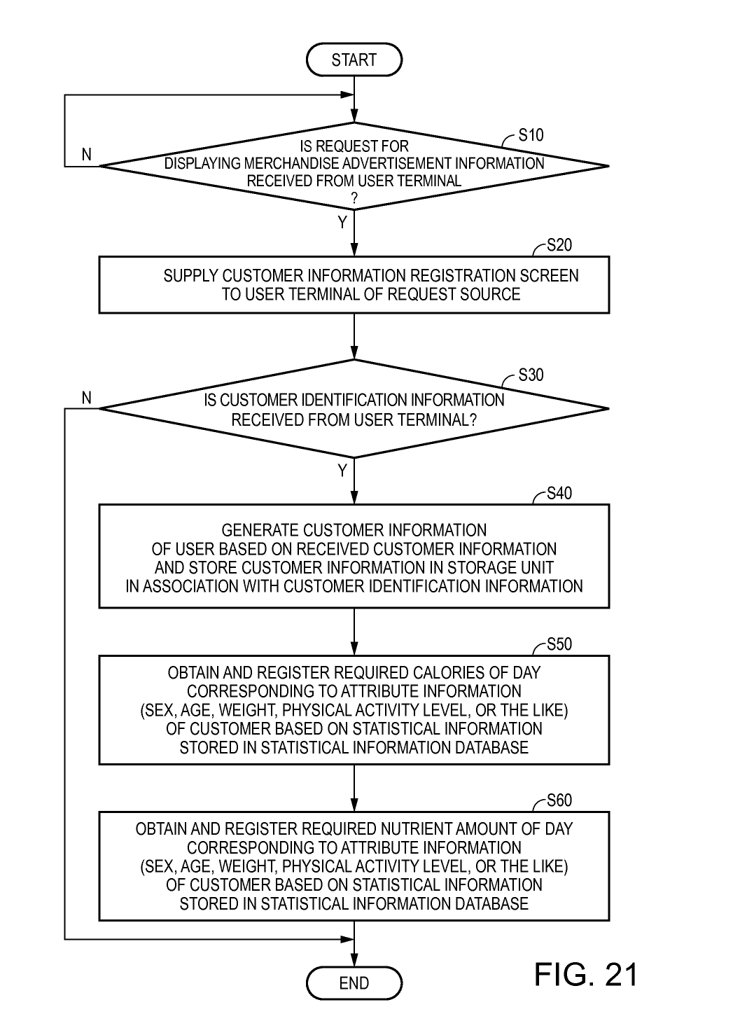

FIG. 21 is a flowchart illustrating the flow of a customer information registration process.

When the management server 20 (the customer information acquisition unit 214) receives a request for registering the customer information from the user terminal (Y in step S10), the management server 20 transmits a customer information registration image (a customer information registration screen on which the customer performs inputting to register the customer information) to the user terminal 10 of the request source (Step S20).

When the management server 20 receives the customer information input via the customer information registration image (Y in step S30), the management server 20 generates the customer information (262 in FIG. 2, 330 and 300 in FIGS. 11A and 11B, or the like) of the user based on the received customer information and stores the customer information in the storage unit 260 (the customer information database 32 in FIG. 1) in association with the customer identification information (Step S40).

The required calories of a day corresponding to the attribute information (sex, age, weight, physical activity level, or the like) of the customer are calculated based on the statistical information 264 stored in the statistical information database (34 in FIG. 1) and the required calories are registered as the required calories (362 in FIG. 27) in association with the customer identification information (step S50). For example, according to the method described in “2-5. Process of Calculating Required Calories During Nutrient Analysis Period,” the required calories in a day can be obtained.

Based on the statistical values stored in the statistical information database, a required amount of each nutrient of a day corresponding to the attribute information (the sex, the age, the weight, the physical activity level, or the like) of the customer is obtained and registered as the required nutrient amount (364 in FIG. 27) in association with the customer identification information (Step S60). For example, according to the method described in “2-5. Process of Calculating Required Calories During Nutrient Analysis Period,” the required calories in a day can be obtained.

### 2-11. Nutrition Analysis Process

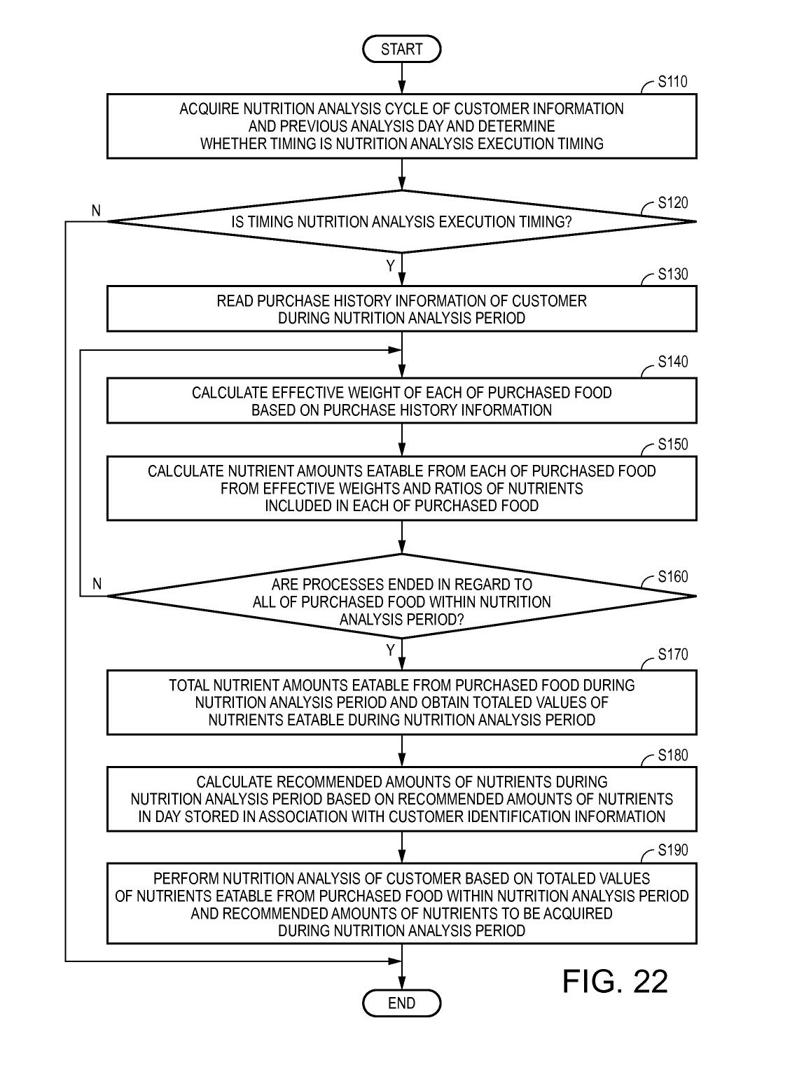

FIG. 22 is a flowchart illustrating the flow of a nutrition analysis process according to the embodiment.

The management server 20 (the nutrition analysis processing unit 218) acquires the nutrition analysis cycle (336 in FIG. 11A) of the customer information and the previous analysis day (338 in FIG. 11A) and determines whether a timing is a nutrition analysis execution timing (step S120). When the timing is the nutrition analysis execution timing (Y in step S120), the following processes are performed.

The purchase history information 266 of the customer during the nutrition analysis period is read (step S130). Since the management server 20 can store the purchase history information of the customers collected from each store as the purchase history information (266 in FIG. 2 and FIG. 28) in the storage unit 260 (corresponding to the purchase history information database 39) in association with the customer information during a predetermined period (which is a period in which the purchase history information is used for at least the nutrition analysis process), the management server 20 reads the purchase history information from the storage unit 260.

Next, the effective weight of each of the purchased food is calculated based on the purchase history information (step S140). For example, according to the method described with (Expression 5) of “2-7. Process of Calculating Nutrients Acquired During Nutrient Analysis Period,” the effective weight of each of the purchased food may be calculated. Then, the nutrient amounts eatable from each of the purchased food are calculated from the effective weights and the ratios of the nutrients included in each of the purchased food (step S150).

When the processes of step S140 to step S150 are ended in regard to all of the purchased food within the nutrition analysis period (Y instep S160), the nutrient amounts eatable from the purchased food during the nutrition analysis period are totaled and totaled values of the nutrients eatable during the nutrition analysis period are obtained (step S170).

The recommended amount of each nutrient during the nutrition analysis period is calculated based on the recommended amount (366 in FIG. 27) of each nutrient in a day stored in association with the customer identification information (step S180). For example, when the length of the nutrition analysis period of the customer is one week, the recommended amount of each nutrient during the nutrition analysis period for nutrient recommendation of one day of each nutrient (protein, fat, and carbohydrate)×7 days can be calculated.

Then, the nutrition analysis of the customer is performed based on the totaled values of the nutrients eatable from the purchased food during the nutrition analysis period and the recommended amounts of the nutrients to be obtained during the nutrition analysis period (step S190). For example, according to the method described in “2-8. Process of Calculating Nutrient Excess or Deficiency Information,” the nutrition analysis of the customer may be performed.

### 2-12. Process of Supplying Recommended Merchandise Information

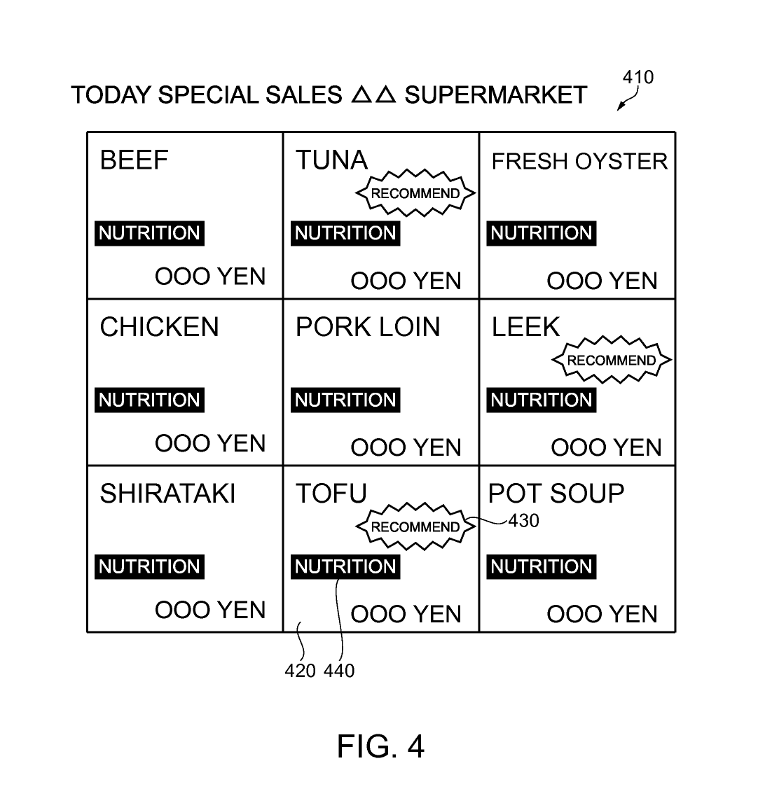

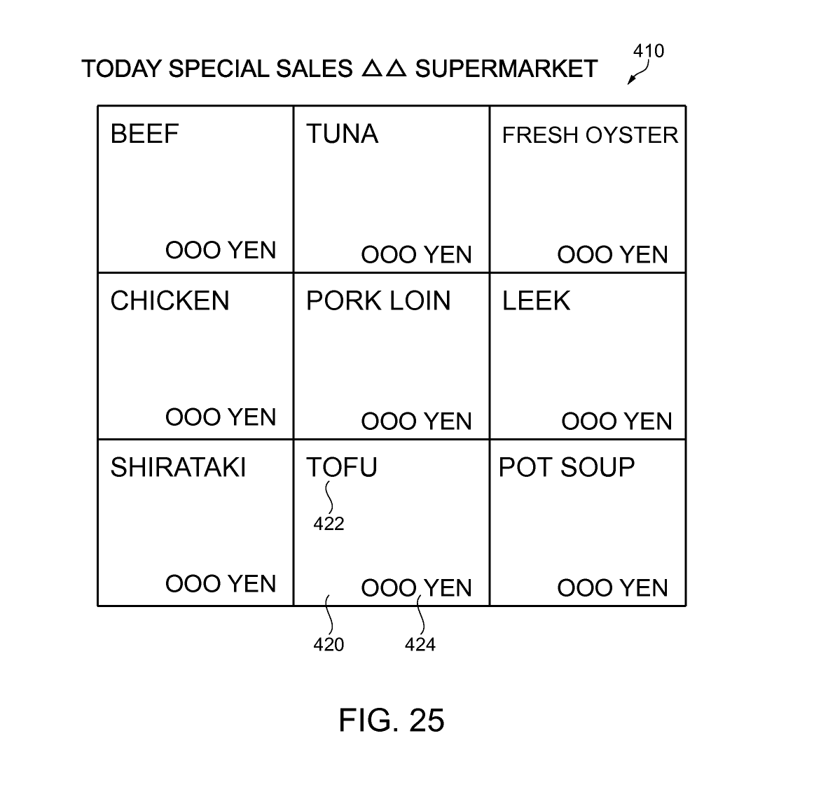

FIGS. 25 and 4 illustrate electronic advertisement (which is an example of the merchandise advertisement information) supplied in the system (FIGS. 1 and 2). The merchandise advertisement information is an image (for example, a Hyper Text Markup Language (HTML) image) supplied on a web. The merchandise advertisement information may be an image (for example, electronic advertisement) designed for advertisement or may be an image (for example, a merchandise purchase screen supplied by an electronic store such as an online supermarket) designed for sales.

The management server 20 opens a nutrition analysis service supply site on a web, and thus the user can access the site via the user terminal to be supplied with electronic advertisement of a store joining the system for the nutrition analysis service or recommended food information (which is an example of merchandise advertisement information) of the electronic store. When a recommended food information supply process is performed by the management server, as illustrated in FIG. 1, the management server 20 may supply the electronic advertisement and the recommended food information. The store server 40 may supply the electronic advertisement and may be linked to the management server 20, and the recommended food information may be supplied by the management server 20.

When the recommended food information supply process is performed by the store server 40, as illustrated in FIG. 2, the store server 40 may supply the electronic advertisement and the recommended food information.

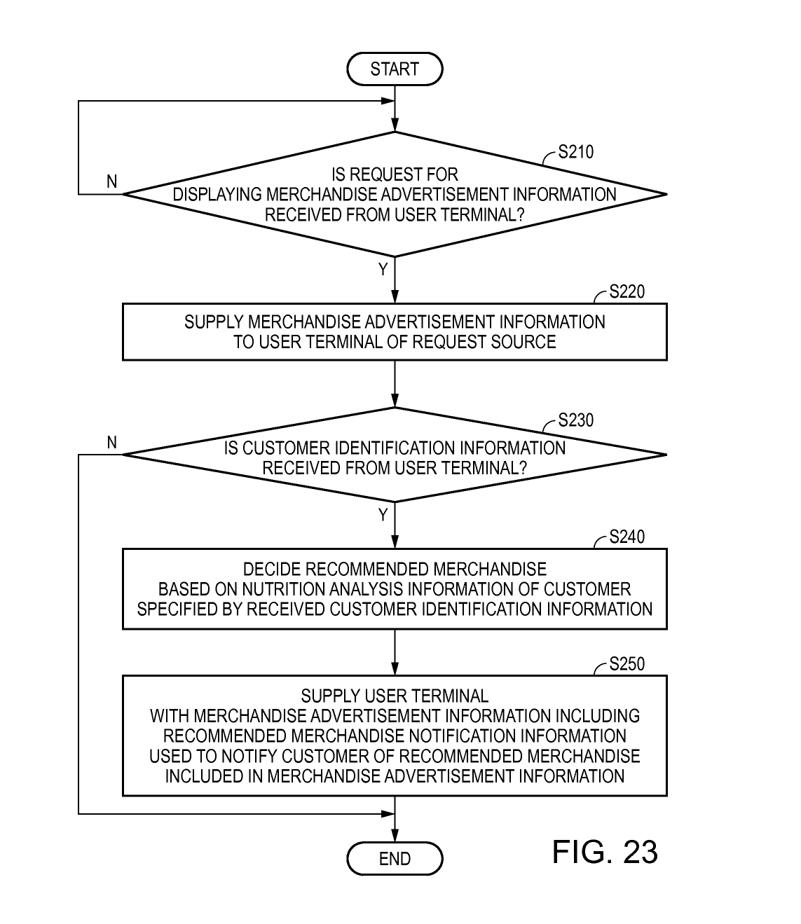

FIG. 23 is a flowchart illustrating the flow of the recommended food information supply process.

When the management server 20 receives a request for displaying the merchandise advertisement information from the user terminal 10 (Y in step S210), the management server 20 supplies the merchandise advertisement information to the user terminal 10 of the request source (step S220). For example, the electronic advertisement (which is an example of merchandise advertisement information) illustrated in FIG. 25 is supplied. The electronic advertisement is electronic advertisement supplied without log-in with a user ID (which may be the customer identification number) or the like and is electronic advertisement (an electronic advertisement not customized for each customer) supplied commonly to all of the users. In the electronic advertisement, information (for example, a food name 422, a price 424, and a food image (not illustrated)) regarding “food” which is merchandise is displayed.

When the management server 20 receives the customer identification information from the user terminal 10 (Y in step S230), the management server 20 decides the recommended merchandise based on the nutrition analysis information of the customer specified by the received customer identification information (step S240). The nutrition analysis information of the customer is, for example, the excess or deficiency information of the recommended amount of each nutrient described in FIG. 19. Accordingly, food (food with a predetermined standard or more) containing many nutrients of which excess or deficiency ratios for the recommended amount satisfy predetermined conditions (for example, the nutrients of which excess or deficiency ratios are equal to or less than predetermined ratio (for example, equal to or less than 80%)) may be decided as the recommended merchandise. When the recommended merchandise is decided, a process of excluding food (food with a predetermined standard or more) containing the nutrients with the upper tolerance amount, that is, the nutrients (for example, the nutrients of which excess or deficiency ratio is equal to or greater than a predetermined ratio (for example, equal to or greater than 100%)) in which excess or deficiency ratio of the upper tolerance amount of the nutrient satisfies a predetermined condition, from the recommended merchandise may be performed.

The management server 20 supplies the user terminal with the merchandise advertisement information including recommended merchandise notification information used to notify the customer of the recommended merchandise included in the merchandise advertisement information (step 5250) . For example, as illustrated in FIG. 4, merchandise advertisement information 410 in which a “recommendation mark” 430 (which is an example of the recommended merchandise notification information) is appended to the recommended merchandise is supplied.

The recommended merchandise to which the “recommendation mark” 430 is appended is food recommended in consideration of a nutrition state of the customer browsing the electronic advertisement and the customer can eat the food to maintain the nutrition state excellently and improve the nutrition state. Accordingly, it is possible to motivate the customer to purchase the food, and thus further to promote the merchandise purchase from the store.

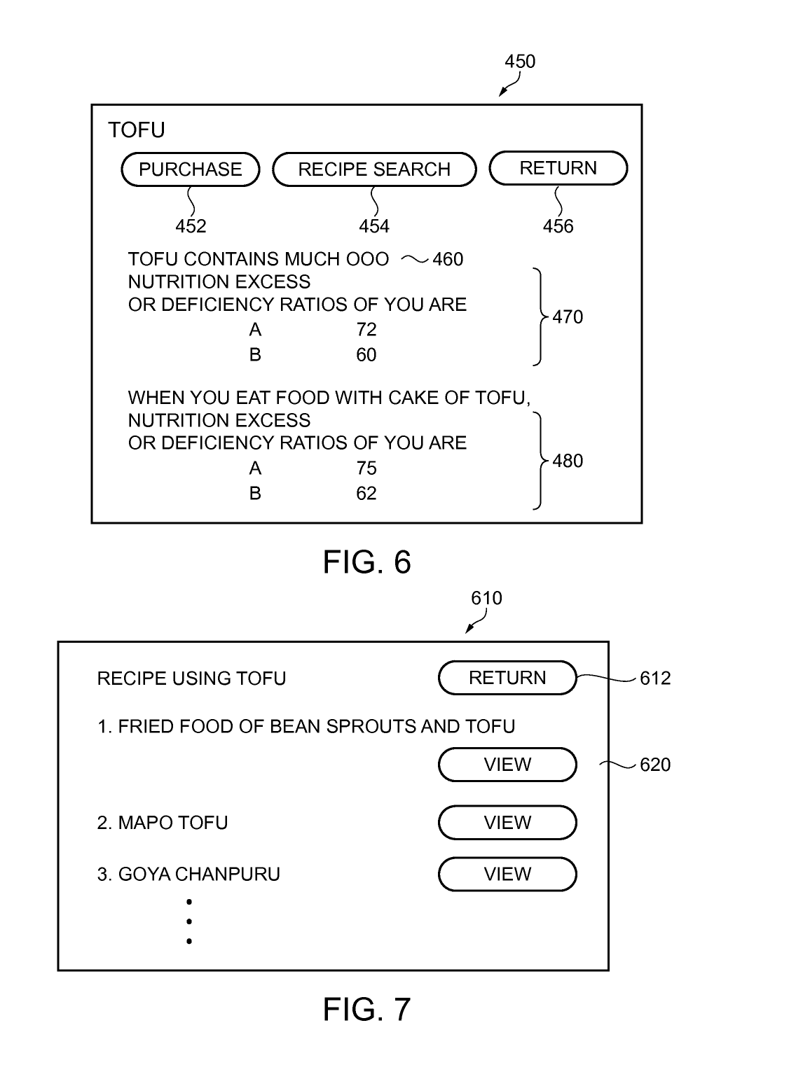

Other nutrition information may be supplied to the user transmitting the customer identification information. For example, when a button of “nutrition” 440 is clicked, a process of supplying various services (see FIGS. 6 to 8) to be described below to the customer may be performed.

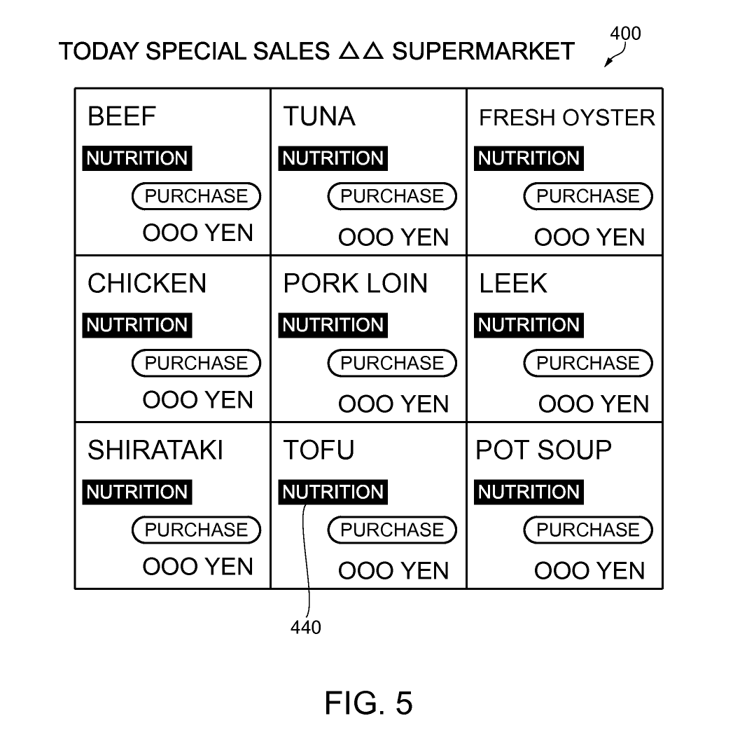

In the case of a type of system transmitting the customer identification information so that the customer logs in, the merchandise advertisement information 410 illustrated in FIG. 5 may be supplied from the beginning.

In the embodiment, the example of the case in which the user browses the image on the site of the web has been described, but the invention is not limited thereto. For example, a case in which the user browses an image with an electronic mail or the like is within the scope of the invention. A case in which the merchandise advertisement information is supplied with a PDF image or the like is also within the scope of the invention.

### 2-13. Nutrition Analysis Simulation Process

FIGS. 5 to 8 illustrate a merchandise purchase screen (which is an example of the merchandise advertisement information) supplied by the system (FIGS. 1 and 2). The merchandise advertisement information is an image (for example, a Hyper Text Markup Language (HTML) image) supplied on a web. The merchandise advertisement information may be an image (for example, electronic advertisement) designed for advertisement or may be an image (for example, a merchandise purchase screen supplied by an electronic store such as an online supermarket) designed for sales.

The management server 20 opens a nutrition analysis service supply site on a web, and thus the user can access the site via the user terminal to be supplied with a nutrition analysis simulation result when the customer eats the advertised merchandise (food) on the electronic advertisement of the store or the electronic store joining the system of the nutrition analysis service.

When the management server 20 performs the nutrition analysis simulation process, as illustrated in FIG. 1, the management server 20 may supply the merchandise purchase screen and supply the result of the nutrition analysis simulation process. The store server 40 may supply the merchandise purchase screen and link to the management server 20 so that the result of the nutrition analysis simulation process is supplied from the management server 20.

When the store server 40 performs the recommended food information supply process, as illustrated in FIG. 2, the store server 40 may supply the merchandise purchase screen and supply the result of the nutrition analysis simulation process.

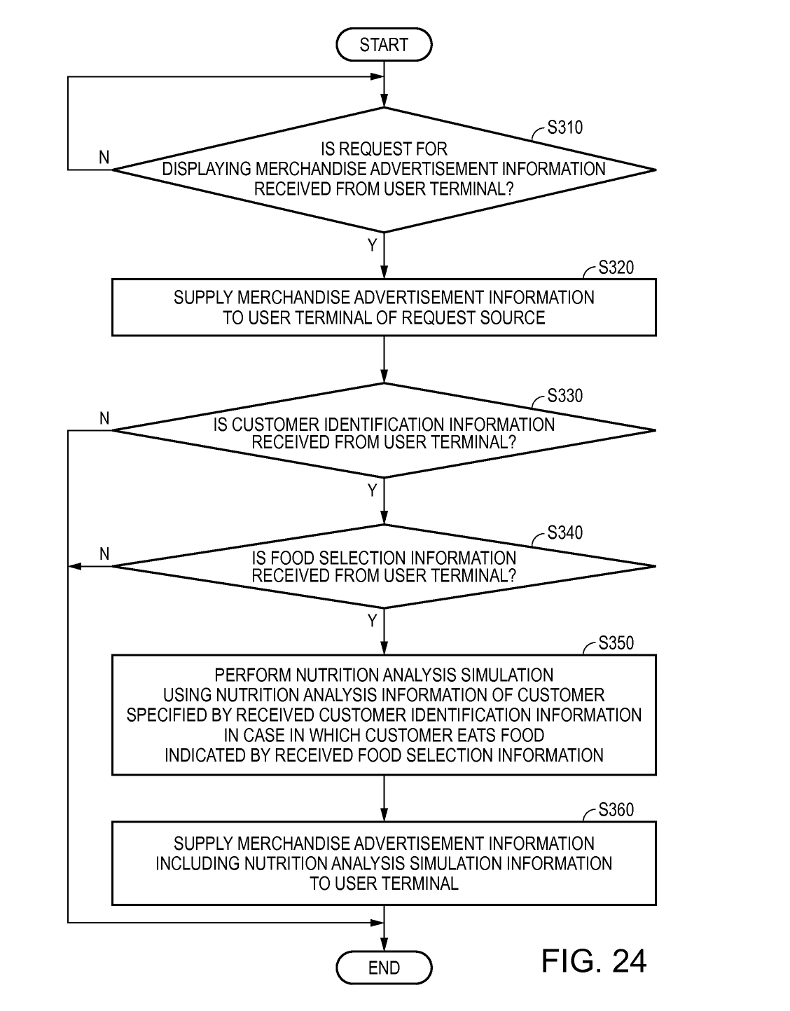

FIG. 24 is a flowchart illustrating the flow of the nutrition analysis simulation process.

When the management server 20 receives a request for displaying the merchandise advertisement information from the user terminal (step S310), the management server 20 supplies the merchandise advertisement information to the user terminal of the request source (step S320).

For example, a merchandise sale screen (which is an example of the merchandise advertisement information) illustrated in FIG. 5 is supplied. The merchandise sale screen is a merchandise sale screen supplied even without log-in with a user ID (which may be the customer identification number) and is a merchandise sale screen commonly supplied to all of the users. Information (for example, food names, prices, and food images (not illustrated)) regarding “food” which is merchandise, “purchase button” images, and “nutrition button” images 440 are displayed on the merchandise sale screen. The management server 20 performs a merchandise purchase process when the “purchase button” image is instructed (for example, clicked).

When the management server 20 receives the customer identification information from the user terminal (Y in step S330) and further receives the food selection information from the user terminal (Y in step S340), the management server 20 performs the nutrition analysis simulation using the nutrition analysis information of the customer specified by the received customer identification information in the case in which the customer eats the food indicated by the received food selection information (step S350) and supplies the merchandise advertisement information including the nutrition analysis simulation information to the user terminal (step S360).

FIG. 6 illustrates an image (which is an example of the merchandise advertisement information including the nutrition analysis simulation information) displayed when the user gives an instruction of the “nutrition button” image 440 (for example, clicks) of “tofu” (when “tofu” is received as the food selection information) on the screen of FIG. 5. As illustrated in the drawing, current nutrition excess or deficiency information 470 of the user (customer) and nutrition excess or deficiency information 480 when the user (customer) eats “tofu” which is the selected food are displayed as a simulation result. With regard to the nutrition excess or deficiency ratios before tofu is eaten, the excess or deficiency ratio of “nutrition A” is 72% and the excess or deficiency ratio of “nutrition B” is 60%. The fact that the excess or deficiency ratio of “nutrition A” is changed to 75% and the excess or deficiency ratio of “nutrition B” is changed to 62% after “tofu” is eaten is displayed. The nutrients to be displayed may be nutrients that satisfy a predetermined condition. For example, nutrients of which the excess or deficiency ratios of the customers are equal to or less than predetermined values or nutrients of which change ratios of the values of the excess or deficiency ratios are equal to or greater than predetermined values after the food is eaten may be preferentially displayed.

The nutrition analysis information of the customer is, for example, excessive or deficient information regarding the recommended amount of each nutrient described in FIGS. 11A and 11B. The system simulates how the excess or deficiency information is changed when food which is the selected merchandise is eaten, using the nutrition analysis information. Specifically, the nutrition excess or deficiency information 480 used when the user (customer) eats “tofu” which is the selected merchandise can be obtained by calculating the excess or deficiency information regarding the merchandise purchased within the nutrition analysis period in addition to the food selected as the food selection information by the user according to the method described in “2-7. Process of Calculating Nutrients Acquired During Nutrient Analysis Period.”

As illustrated in FIG. 6, a “purchase button” image 452, a “recipe search button” image 454, and a “return button” image 456 may be formed. When the “purchase button” image 452 is instructed, the management server 20 supplies the user terminal with a screen for merchandise purchase. When the user sees the simulation result and considers purchasing the merchandise, the user can instruct the “purchase button” image 452 to purchase the merchandise. When the “return button” image 456 is instructed, the screen returns to the screen of FIG. 5.

When the “recipe search button” image 454 is instructed, the management server 20 supplies the user terminal with a recipe list image 610 illustrated in FIG. 7. In the recipe list image 610, a list of recipes in which the selected food (here, “tofu”) is used is displayed. As a display order of the list, recipes in which food ingredients containing nutrients (for example, nutrients of which the excess or deficiency ratios are predetermined ratios) deficient for the user are much used may be displayed at a higher rank. Specifically, according to the method described in “2-7. Process of Calculating Nutrients Acquired During Nutrient Analysis Period,” a change in the excess or deficiency state of the nutrients when the user eats a dish of each recipe is obtained by calculating the excess or deficiency information so that the food included as food ingredients of the recipe selected as the food selection information by the user is included in the merchandise purchased within the nutrition analysis period. Improvement rates of the nutrition states of the customer when the customer eats the dish of each recipe may be evaluated based on this change in the excess or deficiency state so that the recipes are displayed at a higher rank as the improvement ratios are higher. An indication reporting the improvement rate may be added to the recipe.

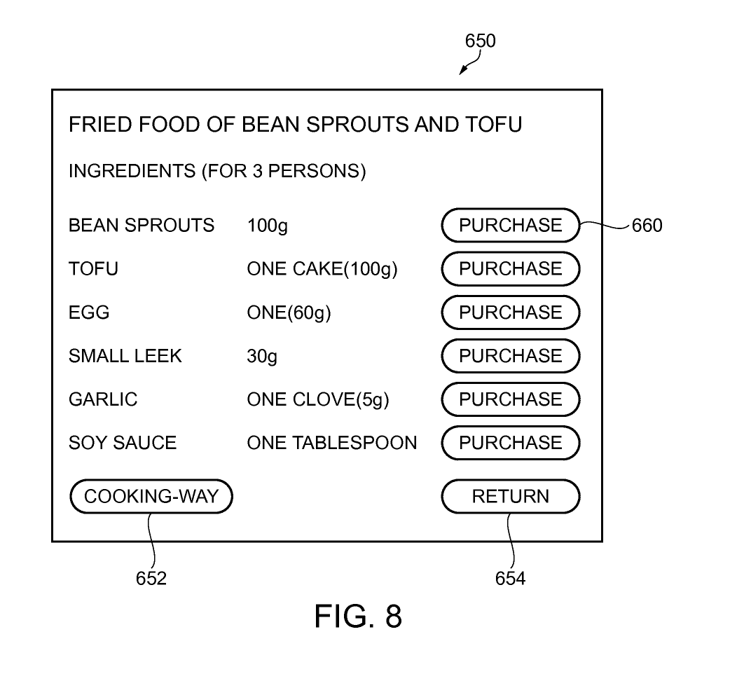

In FIG. 7, when a “view button” image 620 corresponding to each recipe is instructed, the management server 20 supplies the user terminal with a recipe image 650 illustrated in FIG. 8. In the recipe image, necessary ingredients are displayed and a “purchase button” image 660 corresponding to each ingredient is also formed. Thus, the user can view the recipe and purchase insufficient ingredients. A “cooking-way button” image 652 is also formed in the recipe image 650. When “cooking-way button” image 652 is instructed, the management server 20 supplies the user terminal with an image displaying a cooking way of the recipe. Thus, since the user reduces the labor and time for investigating the cooking way, it is possible to promote the purchase of the merchandise of the user.

The embodiment and the modification examples have been described above, but the invention is not limited to the embodiment and the modification examples. The invention can be embodied in various aspects within the scope of the invention without departing from the gist of the invention.

### 2-13. Recipe Information Database

FIG. 29 is a diagram illustrating an example of registration contents of the recipe information of the recipe information database.

The recipe information 500 includes a recipe ID 502, a copy source ID 504, a recipe title (dish name) 506, a category 508, classification 510, an open day 512, a user ID 514, a dish image 516, food ingredient information 518, cooking-way information 520, report information 522, nutrient information 524, and recommended pregnancy week information 626.

The food ingredient information 518 may be configured as information including a food ingredient name 542 and a quantity 544, for example, as indicated by 540.

The cooking-way information 520 may be configured as information including a cooking-way order 552, a cooking-way description 554, and a cooking-way photo 556, for example, as indicated by 550.

The report information 522 may be configured as information including a report ID 562, a poster 564, a chef photo 566, a posting day 568, and a comment 569, for example, as indicated by 560.

The nutrient information 524 may be configured as information including a nutrient name 572, a unit 574, and a nutrient amount (for one person) 576, for example, as indicated by 570.

The report information 522 is information generated when a user other than a user registering the recipe makes food with reference to the recipe and posts a comment such as a photo, a thought, or the like. In the embodiment, when the user posts the recipe and, for example, the user wants to change the recipe a little with reference to a certain recipe, the user can copy the original recipe, modify the recipe, and register the recipe newly. In this case, the recipe ID of the copy source is also registered as the copy source ID 504. Further, basic cooking menus may be registered in advance in the system so that the user rarely makes an effort to post the recipe from the beginning.

The recommended pregnancy week information 626 is information (which may be a period of time or information regarding months of pregnancy) regarding pregnancy weeks proper for the recipe. The recommended pregnancy week information 626 may be registered when the user registers the recipe or may be set in the system. For example, when an “early period” is registered as the recommended pregnancy week information 626, the recipe becomes a recipe proper for an early pregnancy period (1 to 15 weeks). When the recipe information is displayed based on a recipe search result and the pregnancy weeks of the user are identical to (or is close to) the pregnancy weeks recommended by the recommended pregnancy week information during the recipe search, the recipe information may be preferentially displayed. Further, a recommendation mark or the like may be displayed in the recipe and the user may be notified that the recipe is highly recommended.

The invention includes configurations which are substantially the same as the configurations described in the embodiment (for example, configurations of the same functions, methods, and results or configurations of the same objectives and advantages). The invention includes configurations in which portions which are not essential portions of the configurations described in the embodiment are substituted. The invention includes configurations in which the same operational advantages as those of the configurations described in the embodiment are obtained or configurations in which the same objectives can be achieved. The invention includes configurations in which known technologies described in the embodiment are added.

In the foregoing embodiment, nutrition analysis which is based on the health state information (318 in FIG. 11B) of the customer may be performed. For example, an item registered as the health state information is supplied as an option on the customer information registration screen so that the customer can input the option. For example, information regarding required nutrients corresponding to options may be prepared in the system, information regarding the required nutrients corresponding to the options of the customer may be obtained, and recommended merchandise may be decided using the information.

The entire disclosure of Japanese Patent Application No. 2014-053139, filed Mar. 17, 2014 is expressly incorporated by reference herein.

1. A nutrition analysis system comprising:
a customer information acquisition unit that acquires customer information including attribute information of a customer;
a purchase history information acquisition unit that acquires purchase history information of food of the customer;
a nutrition analysis processing unit that calculates a required nutrient amount of the customer based on the attribute information of the customer and performs nutrition analysis of the customer based on the purchase history information and the required nutrient amount of the customer to generate nutrition analysis information of the customer; and
a merchandise advertisement information supply unit that decides recommended merchandise for the customer based on the nutrition analysis information of the customer and supplies merchandise advertisement information including recommended merchandise notification information used to notify the customer of the recommended merchandise.

2. A nutrition analysis system comprising:
a customer information acquisition unit that acquires customer information including attribute information of a customer;
a purchase history information acquisition unit that acquires purchase history information of food of the customer;
a nutrition analysis processing unit that calculates a required nutrient amount of the customer based on the attribute information of the customer and performs nutrition analysis of the customer based on the purchase history information and the required nutrient amount of the customer to generate nutrition analysis information of the customer; and
a merchandise advertisement information supply unit that supplies merchandise advertisement information to the customer, acquires selection information which is information regarding merchandise selected from the merchandise advertisement information by the customer, performs nutrition analysis simulation when the customer eats the merchandise, based on the nutrition analysis information of the customer and merchandise specified by the selection information, and supplies nutrition analysis simulation information which is a result of the nutrition analysis simulation to the customer.

3. The nutrition analysis system according to claim 1,
wherein the customer information acquisition unit acquires health state information of the customer as the customer information, and
wherein the nutrition analysis processing unit performs the nutrition analysis of the customer using the health state information of the customer.

4. The nutrition analysis system according to claim 2,
wherein the customer information acquisition unit acquires health state information of the customer as the customer information, and
wherein the nutrition analysis processing unit performs the nutrition analysis of the customer using the health state information of the customer.

5. The nutrition analysis system according to claim 1,
wherein the customer information acquisition unit acquires, as the customer information, attribute information of a plurality of household members of the same household jointly consuming purchased food indicated by the purchase history information, and
wherein the nutrition analysis processing unit calculates a required nutrient amount of each member based on the attribute information of each of the household members forming the same household and uses a value obtained by summing the required nutrient amounts of the plurality of household members forming the same household as the required nutrient amount of the customer.

6. The nutrition analysis system according to claim 2,
wherein the customer information acquisition unit acquires, as the customer information, attribute information of a plurality of household members of the same household jointly consuming purchased food indicated by the purchase history information, and
wherein the nutrition analysis processing unit calculates a required nutrient amount of each member based on the attribute information of each of the household members forming the same household and uses a value obtained by summing the required nutrient amounts of the plurality of household members forming the same household as the required nutrient amount of the customer.

7. The nutrition analysis system according to claim 1, wherein the nutrition analysis processing unit decides a cycle at which the nutrition analysis of the customer is performed based on a purchase frequency indicated by the purchase history information of the customer, calculates the required nutrient amount of the customer during a nutrition analysis period to correspond to the decided cycle, and performs the nutrition analysis of the customer based on the calculated required nutrient amount and the purchase history information of the customer during the nutrition analysis period.

8. The nutrition analysis system according to claim 2, wherein the nutrition analysis processing unit decides a cycle at which the nutrition analysis of the customer is performed based on a purchase frequency indicated by the purchase history information of the customer, calculates the required nutrient amount of the customer during a nutrition analysis period to correspond to the decided cycle, and performs the nutrition analysis of the customer based on the calculated required nutrient amount and the purchase history information of the customer during the nutrition analysis period.

9. The nutrition analysis system according to claim 1,
wherein the purchase history information acquisition unit acquires purchase history information of the customer at a plurality of stores, and
wherein the nutrition analysis processing unit performs the nutrition analysis of the customer using the purchase history information of the customer at the plurality of stores.

10. The nutrition analysis system according to claim 2,
wherein the purchase history information acquisition unit acquires purchase history information of the customer at a plurality of stores, and
wherein the nutrition analysis processing unit performs the nutrition analysis of the customer using the purchase history information of the customer at the plurality of stores.

11. The nutrition analysis system according to claim 1 further o isin
a program causing a computer to function as the customer information acquisition unit, the purchase history information acquisition unit, the nutrition analysis ocessin unit, and the merchandise advertisement information supply unit.

12. The nutrition analysis program system according to claim 2 further comprising:
a program causing a computer to function as the customer information acquisition unit, the purchase history information acquisition unit, the nutrition analysis pocessing unit, and the merchandise advertisement information supply unit.

13. A customer terminal comprising:
a customer information acquisition unit that acquires customer information including attribute information of a customer;
a communication unit that transmits the customer information to a server;
a merchandise advertisement information acquisition unit that acquires, from the server, merchandise advertisement information including recommended merchandise notification information to notify the customer of recommended merchandise decided by the server for the customer; and
a merchandise advertisement information supply unit that supplies the merchandise advertisement information to the customer,
wherein the server calculates a required nutrient amount of the customer based on the attribute information of the customer, performs nutrition analysis of the customer based on the required nutrient amount and purchase history information of the customer acquired from a store terminal to generate nutrition analysis information of the customer, and decides the recommended merchandise for the customer based on the nutrition analysis information of the customer.

14. A customer terminal comprising:
a customer information acquisition unit that acquires customer information including attribute information of a customer;
a communication unit that transmits the customer information to a server;
a merchandise advertisement information acquisition unit that acquires, from the server, nutrition analysis simulation information when the customer eats selected food, among merchandise advertisement information supplied to the customer; and
a merchandise advertisement information supply unit that supplies the merchandise advertisement information to the customer,
wherein the server calculates a required nutrient amount of the customer based on the attribute information of the customer, performs nutrition analysis of the customer based on the required nutrient amount and purchase history information of the customer acquired from a store terminal to generate nutrition analysis information of the customer, acquires food selected from the merchandise advertisement information by the customer, performs nutrition analysis simulation when the customer eats the merchandise, based on the nutrition analysis information of the customer and merchandise specified by the selection information, and supplies the nutrition analysis simulation information which is a result of the nutrition analysis simulation.

15. A store terminal comprising:
a purchase history information acquisition unit that acquires purchase history information of food of a customer;
a communication unit that transmits the acquisition of purchase history information to a server;
a customer information acquisition unit that acquires customer information including attribute information of the customer; and
a communication unit that transmits the customer information to the server,
wherein the server calculates a required nutrient amount of the customer based on the attribute information of the customer acquired from a customer terminal, performs nutrition analysis of the customer based on the purchase history information and the required nutrient amount to generate nutrition analysis information of the customer, decides recommended merchandise for the customer based on the nutrition analysis information of the customer, and supplies merchandise advertisement information including recommended merchandise notification information used to notify the customer of the recommended merchandise.

16. The nutrition analysis system according to claim 1 wherein
the system comprises a server:
the customer information acquisition unit acquires the customer information including attribute information of the customer from a customer terminal; and
the purchase history information acquisition unit acquires the purchase history information of food of the customer from a store terminal.

17. The nutrition analysis system according to claim 2 wherein
the system comprises a server:
the customer information acquisition unit acquires the customer information including attribute information of the customer from a customer terminal; and
the purchase history information acquisition unit acquires the purchase history information of food of the customer from a store terminal.
